(19) United States
(12) Patent Application Publication
(10) Pub. No.: US 2008/0245001 A1
(43) Pub. Date: Oct. 9, 2008

(54) Window Cladding Device, Method and System

(76) Inventors: Boulous Paul Alkoury, Newmarket (CA); Christopher H. Kozlowski, Mississauga (CA)

Correspondence Address: FITCH EVEN TABIN AND FLANNERY, 120 SOUTH LA SALLE STREET, SUITE 1600, CHICAGO, IL, 60603-3406, US

(21) Appl. No.: 12/098,269

(22) Filed: Apr. 4, 2008

(30) Foreign Application Priority Data
Apr. 4, 2007 (CA) 2584090

(51) Int. Cl. E06B 3/263; E04C 2/38; E06B 3/30

(52) U.S. Cl. 52/204.5; 52/716.2; 52/717.02

(57) ABSTRACT

A strip of cladding covering an exterior window frame or mullion and joints between the frame or mullion and the surfaces of the adjacent window panes. The strip has a cover with first and second longitudinal opposing sides for placement over the frame or mullion and at least one joint. The first side has a first seal running substantially parallel to the longitudinal axis of the cover for sealing the cover to the exterior surface of a window pane. The second side has a second seal running substantially parallel to the longitudinal axis of the cover for sealing the cover to the frame or another window pane. The cover is attachable to the frame or mullion for sealing the frame and adjacent joint or mullion and adjacent joints between the first seal and the second seal, in a substantially water resistant manner.

### RELATED APPLICATIONS

This application claims priority from and the benefit of Canadian Application No. 2584090, filed Apr. 4, 2007, which is incorporated by reference in its entirety herein.

### FIELD OF THE INVENTION

This invention relates to a device, method and system for cladding windows. In particular, this invention relates to a device, method and system for cladding windows in a substantially water and draft resistant manner providing thermal breaks.

### BACKGROUND OF THE INVENTION

Maintaining the appearance, water tight integrity and energy efficiency of windows in buildings has long been a costly proposition for both residential and business properties. Many older residential and business properties were originally constructed with windows having wooden frames, mullions and sashes. Eventually metal, and in particular aluminum, window frames, mullions and sashes became common place for large multi-unit residential dwellings such as apartment buildings and condominiums. Recently, extruded window frames, particularly with plastic frames have become popular, especially in high end new residential dwellings and as replacement windows in renovations.

Wooden window frames and mullions require significant upkeep in the form of periodic scraping, re-painting and caulking, failing which bare wood is exposed to the elements and the wood begins to decay. Frequently painting does not take place as often as required and wooden window frames and mullions become damaged, sometimes resulting in water leakage, moisture or condensation problems, and mold or mildew. Wooden frames and mullions, and related seals, may also deteriorate to the point that drafts are also created causing significant heating and cooling loss.

While aluminum windows supposedly are maintenance free, not requiring the ongoing scraping, painting and caulking required to maintain wooden window frames, aluminum window frames and mullions are subject to pitting and discoloration. Water leakage, moisture and condensation are also a problem for aluminum windows where the seals between the aluminum and the glass panes have started to break down. Aluminum window frames also readily transfer cold and hot outdoor temperatures applied to the exterior of the aluminum window frames to the interior surfaces of the aluminum window frames resulting not only in significant heat or cooling loss through such frames with poor insulation values, but also causing the interior of the aluminum window frames to be cold or hot to the touch, and potentially causing frost or condensation on the inside surfaces the aluminum window frames and mullions. The seals of aluminum windows can also fail causing drafts and heating and cooling loss.

Newer style vinyl windows are typically much more weather resistant than wood or aluminum and have significantly higher R values. However, even newer style vinyl windows may eventually experience leakage where window panes are attached to the frames.

When windows start to break down as indicated above, the problems are often so extensive that maintenance can not fully restore the damage and the only reliable way to remedy the problem is to replace the entire window, which is an extremely expensive and disruptive task, especially when all the windows of an entire building may be replaced all at once as a prophylactic measure.

While numerous arrangements have been suggested over the years to clad over wooden window frames and mullions to avoid replacing the entire window, such cladding has heretofore concentrated on the aesthetic aspects of covering such window frames and mullions. While such cladding may divert some of the snow and rain which contributes to the weathering of window frames, a substantially water resistant seal between such cladding and window panes has not been taught. Without a substantially water resistant seal between cladding and the window panes themselves, residual amounts of water may continue to leak behind cladding to further damage wooden window frames and potentially cause leakage, moisture and condensation problems and possibly mold or mildew inside a building. While these problems may be reduced by thoroughly scrapping, painting and caulking before installing the cladding, this amounts to doing the job twice which is not economically viable. Even if such pre-installation preparation is performed, the wood may have deteriorated such that water resistant sealing is not possible. Furthermore, the paint and caulking may continue to erode due to outdoor heat and cold resulting in expansion and contraction of the paint and caulking.

Cladding for aluminum windows, and in particular aluminum cladding for aluminum windows has thus far not been taught. Water leakage, drafts and heating and cooling loss continue to be problems for older aluminum windows.

Accordingly, a way to seal the edges of new exterior window cladding against the exterior of an existing window, without disassembling, removing or replacing the existing window, in a substantially water and draft resistant manner which reduces the transfer of heat and cold from the cladding to the frame and mullions is desirable.

### SUMMARY OF THE INVENTION

Windows may have a single window pane and simply be supported by a window frame comprising an upper head, a lower sill, and two side jambs. Windows may also have multiple window panes supported by the window frame as well as one or more mullions or bars. In this specification, window pane support members refers to both window frames, frame members and window mullions, and frame members refers to heads, jambs and sills. As heads, jambs, sills, and mullions are usually oriented horizontally or vertically, they are referred to as such in this specification, however, they need not necessarily be oriented horizontally or vertically.

By one approach, a strip of window cladding covers a length of exterior window pane support member and at least one exterior joint along the length of the exterior window pane support member where an exterior surface of the window pane support member meets an exterior surface of at least one window pane supported by the window pane support member. The strip includes a cover having first and second longitudinal opposing sides for placement over the exterior window pane support member and the at least one joint. The first side has a first seal operatively attached to the cover, the first seal running substantially parallel to the longitudinal axis of the cover for sealing the cover to the exterior surface of one of the at least one window pane. The second side has a second seal operatively attached to the cover, the second seal running substantially parallel to the longitudinal axis of the cover, for sealing the cover to the window. The cover is attachable to the exterior window pane support member for sealing the length of exterior window pane support member and the at least one joint between the first seal and the second seal in a substantially water resistant manner.

In one aspect, the strip is attached to a frame member wherein the strip covers the frame member and the one joint between the frame member and an adjoining window pane wherein the first seal seals the first side of the cover to the exterior surface of the adjoining window pane and the second seal seals the second side of the cover to the frame member.

In another aspect, the strip is attached to a mullion wherein the strip covers the mullion and one joint on either side of the mullion each between the mullion and one of two adjoining window panes wherein the first seal seals the first side of the cover to the exterior surface of one adjoining window pane and the second seal seals the second side of the cover to the exterior surface of another adjoining window pane.

In another aspect, the strip is adapted such that the first seal is for sealing the cover to a sash frame and the second seal is for sealing the cover to a frame member.

In another aspect, the strip is adapted such that the first seal is for sealing the cover to a sash frame and the second seal is for sealing the cover to a mullion.

In another aspect, the strip is adapted to comprise an angled window sill comprising only a first seal for sealing an upper end of the strip substantially horizontally across the surface of at least one window pane.

Other aspects of the invention are also disclosed in the brief detailed description of embodiments of the invention.

### BRIEF DESCRIPTION OF THE DRAWINGS

FIG. 1 is a sectional side view of an example window frame and mullion cladding assembly shown uninstalled on a window;

FIG. 2 is a fragmented perspective view of an example corner joint of one length of window frame cover showing a corner key installed with cap removed;

FIG. 3 is a perspective view of a simple prior art aluminum window with no moving sash and flush window sill shown attached to a building;

FIG. 4 is a perspective view of an example window frame cover assembly shown attached to the window of FIG. 3;

FIG. 5 is an exploded perspective view showing the addition of an example horizontal mullion cover to the window of FIG. 4;

FIG. 6 is an exploded perspective view showing the addition of example vertical mullion covers to the window of FIG. 5;

FIG. 7 is a perspective view showing the window frame and mullion covers of FIGS. 4, 5 and 6 on the window of FIG. 3;

FIG. 8 is an exploded perspective view of caps for the window frame and mullion covers of FIGS. 4, 5, 6 and 7 as installed on the window of FIG. 3;

FIG. 9 is a perspective view showing the window frame and mullion cladding of FIG. 8 as installed on the window of FIG. 3;

FIG. 10 is a fragmented horizontal sectional top view of a window frame jamb, head or flush sill with an example window frame cladding thereon shown with background removed and attached to a building;

FIG. 11 is a fragmented horizontal sectional top view of a vertical window mullion with example cladding thereon with continuous upper horizontal mullion cladding gasket in the background;

FIG. 11a is a fragmented horizontal sectional top view of a vertical window mullion with example cladding thereon with reliefs in upper horizontal mullion cladding gasket in the background;

FIG. 12 is a fragmented vertical sectional side view of a horizontal window mullion with example cladding thereon with upper and lower vertical mullion gaskets in the background;

FIG. 13 is a horizontal sectional top view of a window with vertical mullion cladding removed showing example vertical frame cladding with horizontal mullion cladding in the background showing continuous upper gasket of horizontal mullion cladding;

FIG. 14 is a horizontal sectional top view of a window with vertical mullion cladding removed showing example vertical frame cladding and horizontal mullion cladding in the background showing gasket reliefs at intersections of vertical mullion face and vertical mullion sides;

FIG. 15 is a horizontal sectional top view of the window of FIG. 9 taken along line 15-15 showing the vertical frame cladding in section and showing the horizontal mullion and the horizontal mullion cladding in section;

FIG. 16 is a side sectional view of an example asymmetrical window frame and mullion cladding assembly shown uninstalled;

FIG. 16a. is a sectional side view of an example window frame and mullion cladding assembly with elongated cover arms shown uninstalled;

FIG. 17 is a fragmented horizontal sectional top view of the asymmetrical window frame and mullion cladding of FIG. 16 as installed on a window frame jamb with recessed adjoining window pane;

FIG. 18 is a fragmented sectional side view of the window frame and mullion cladding of FIG. 16a as installed on a horizontal mullion with recessed upper and lower adjoining window panes;

FIG. 19 is a perspective view of a prior art window with a projecting sill with no movable sash shown attached to a building;

FIG. 20 is a sectional side view of an example window frame cladding for covering a projecting or non-projecting sill;

FIG. 21 is a perspective view of the sill cladding of FIG. 20 showing drainage apertures in support legs;

FIG. 22 is a perspective view of the sill cladding of FIGS. 20 and 21 as installed on the window of FIG. 19;

FIG. 22a is a fragmented perspective view of the junction of frame jamb cladding and sill cladding of FIG. 22;

FIG. 23 is a horizontal sectional top view of the window of FIG. 22 taken along line 23-23 showing example sill cladding and continuous sill gasket as applied against vertical window frame jambs, vertical mullion and window panes, with vertical frame cladding and vertical mullion cladding removed for clarity;

FIG. 24 is a horizontal sectional top view of the window of FIG. 22 taken along line 23-23 showing example sill gasket with gasket divisions as applied against vertical window frame jambs, vertical mullion and window panes, with vertical frame cladding and vertical mullion cladding removed for clarity;

FIG. 25 is a fragmented perspective view of example horizontal window mullion cladding with continuous upper and lower gaskets overlying vertical mullions;

FIG. 25a is a fragmented exploded perspective view of the horizontal window mullion cladding of FIG. 25 showing continuous upper and lower gaskets;

FIG. 26 is a fragmented perspective view of a example horizontal window mullion cladding with one size of gasket overlying window panes and a smaller size of gasket overlying vertical mullions;

FIG. 26a is a fragmented exploded perspective view of the horizontal window mullion cladding of FIG. 26 showing different sized gasket segments;

FIG. 27 is a front view of the outside of a prior art window with a slidable sash;

FIG. 28 is a vertical sectional side view of a partially cladded sash access to cover the window of FIG. 27 taken along line 28-28 showing the location of the lower gasket of the example horizontal mullion cladding and the gasket of the sill cladding adjacent the sash;

FIG. 29 is a horizontal sectional top view of a partially cladded sash access to cover the window of FIG. 27 taken along line 29-29 showing the location of the vertical gaskets of the example window frame cladding and mullion cladding adjacent the sash with sash in closed position;

FIG. 30 is a vertical sectional side view showing the lower arm of example horizontal mullion cladding abutting the front of the horizontal mullion;

FIG. 31 is a horizontal sectional top view showing the example vertical mullion cladding arm closest to a movable sash abutting the front of the vertical mullion;

FIG. 32 is a front view of an example window cladding assembly showing cladding of different profiles surrounding a moveable sash;

FIG. 33 is a fragmented perspective view of the cladding of FIG. 32 taken along line 33-33 showing two different profiles of horizontal mullion cladding and two different profiles of sill cladding;

FIG. 34 is a vertical sectional side view of the cladding of FIGS. 32 and 33 taken along line 33-33;

FIG. 35 is a horizontal sectional top view of the cladding of FIGS. 32, 33 and 34 taken along line 35-35 showing a different profile of vertical mullion cladding for abutting a moveable sash and a different profile of vertical frame cladding for abutting a moveable sash;

FIG. 36 is a vertical sectional side view of the cladding of FIGS. 28 and 29 substituting example sash cladding inserts for gaskets surrounding sash access;

FIG. 37 is a perspective view of the horizontal mullion and sill cladding inserts of FIG. 36 with vertical mullion cladding removed;

FIG. 38 is a sectional top view of an alternate inner thermal break adapted to conform to the shape of an irregular profile of window frame showing the use of a leaf gasket against a window pane;

FIG. 39 is a typical prior art bulb gasket;

FIG. 40 is a typical prior art leaf gasket;

FIG. 41 is a graphic representation of a typical prior art pile gasket.

### DETAILED DESCRIPTION OF THE PREFERRED EMBODIMENTS

Examples of various embodiments of the invention are set out below with references to the figures. It is to be understood that the embodiments set out below are by way of example and are not intended to limit the scope of the invention.

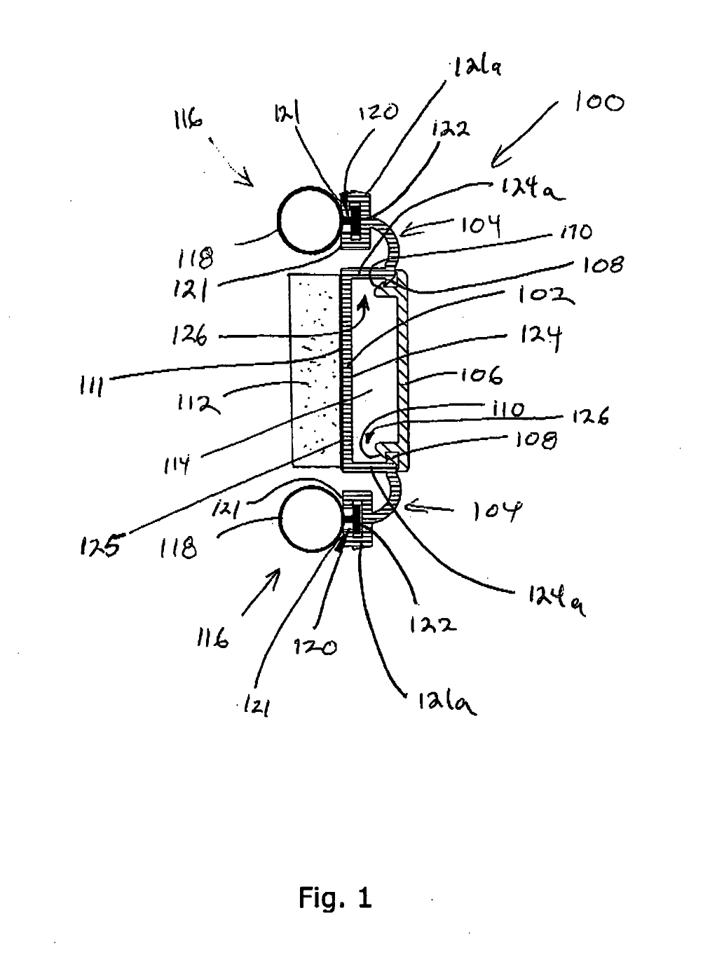

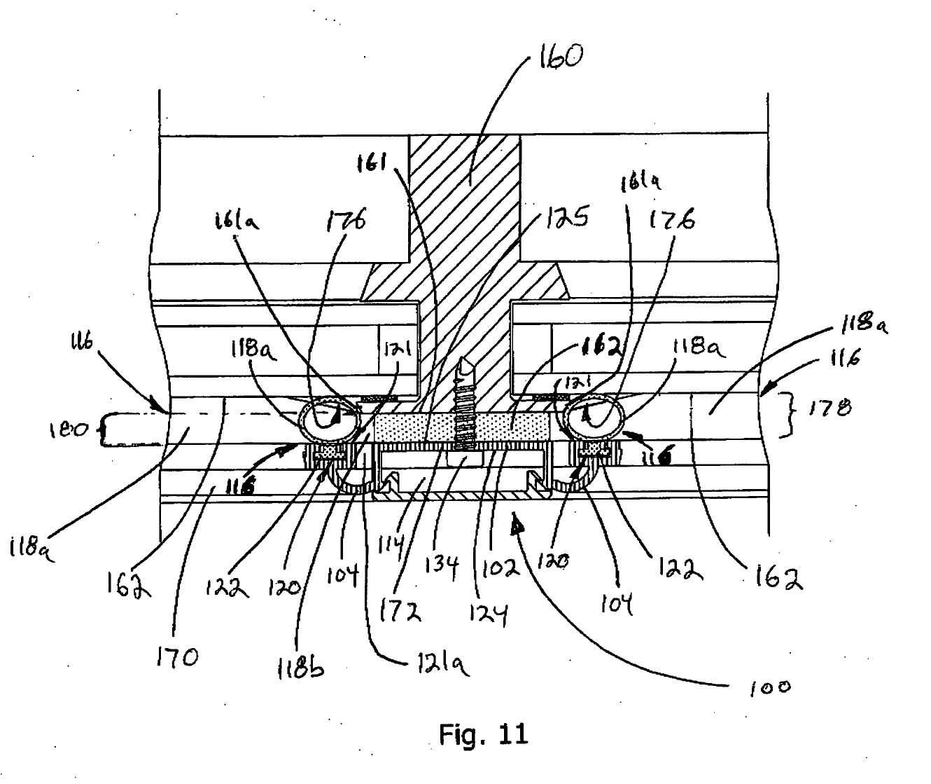

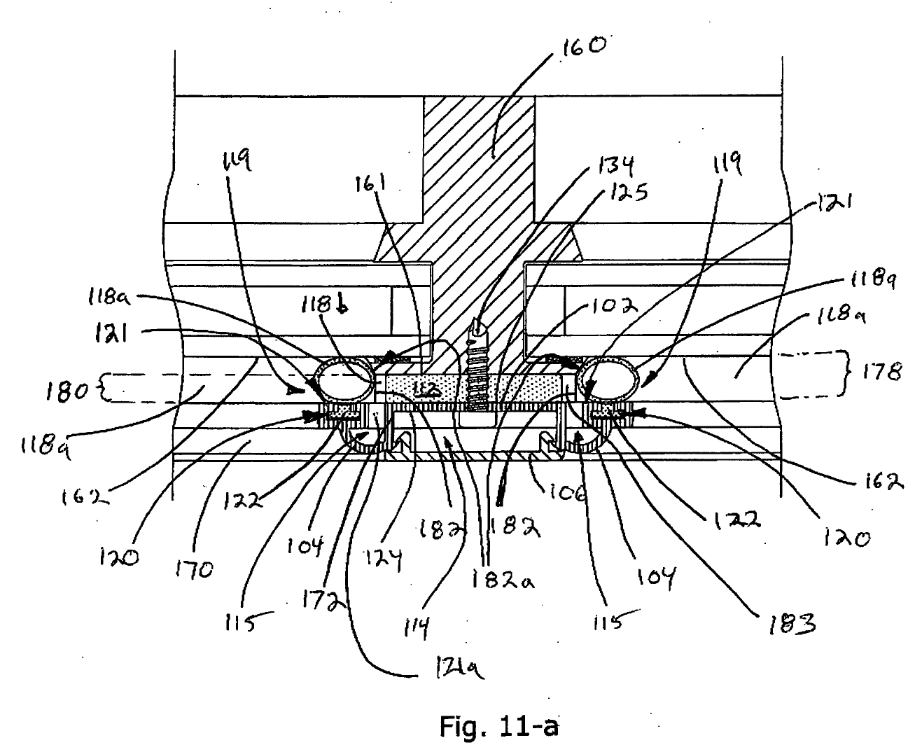

FIG. 1 discloses an example embodiment of a novel window cladding 100 apparatus for covering at least a portion of a window pane support member and at least one joint for the window pane support member. The apparatus includes a cover 102 having first and second longitudinal opposing sides. The cover 102 is configured to be attachable to the window pane support member to cover at least a portion of the window pane support member and the at least one joint. The apparatus also includes a first seal operatively attached to the first longitudinal opposing side, the first seal running substantially parallel to the longitudinal axis of the cover and configured to provide a substantially water resistant seal against at least one of a window pane, a window pane support member, and a window sealing material. A second seal similar to the first seal is operatively attached to the second longitudinal opposing side. By one approach, the first seal is configured to seal the cover to a first window pane and the second seal is configured to seal the cover to a second window pane when the cover is attached to the window pane support member, such as a mullion or horizontal support (see, for example, FIG. 11).

The cover 102 has a cover bottom 124 extending between cover walls 124a. First and second cover arms 104 are connected along at least a portion of the first and second longitudinal opposing sides. The cover arms 104 connect cover walls 124a to and support seal retaining tracks such as gasket compression heads 121a. The first seal and second seals may comprise, for example, gaskets, although other sealing materials and methods may be used. Gasket compression heads 121a comprise a T shaped gasket retaining track 120. Although a T shaped gasket retaining track is shown in FIG. 1 and other embodiments, it is to be understood that any means for connecting a gasket to the gasket compression head would suffice. Bulb gasket 116 comprises a deformable bulb 118 and a gasket retaining head element 122. T shaped gasket retaining head element may be made of Ethylene-Propylene-Diene-Monomer (“EPDM”), which may be bonded to deformable bulb 118, which also may be made of EPDM or poly-vinyl chloride (“PVC”). Notwithstanding the aforesaid materials, it is to be understood that gasket retaining head element 122 and deformable bulb 118 may be made of the same material or different materials so long as bulb gasket 116 is held in a position to be compressed against gasket compression surfaces 121.

Gasket compression heads 121 may not be required with other types of gaskets such as leaf gasket 249 (as shown in FIG. 40), as long as the gasket seals against an exterior window pane surface 162. Other types of suitable gaskets known by those skilled in the art may be employed. Although gasket compression surfaces 121 are shown at the same depth as cover back 125 in cladding 100, the relative depths will vary depending upon the distance between frame face 157 or mullion face 161 (not shown) and exterior window pane surface 162.

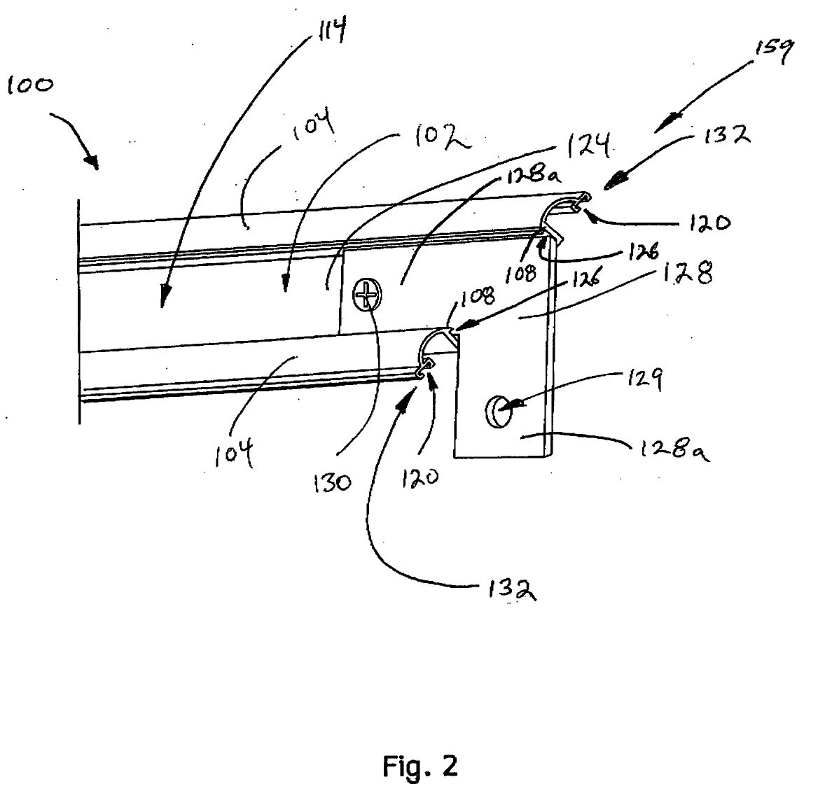

The inside of opposing cover walls 124a comprise longitudinal cover teeth 108 that engage cap teeth 110 of removable cap 106. Cap 106 connects cover walls 124a thereby defining outer thermal break 114. The cavity comprising outer thermal break 114 comprises corner key clearances 126 between cover bottom 124 and the bottom ends of cap teeth 110 to allow corner key 128 (shown in FIG. 2) to align the four perpendicular corners of window frame cover assembly 109 (shown in FIG. 4).

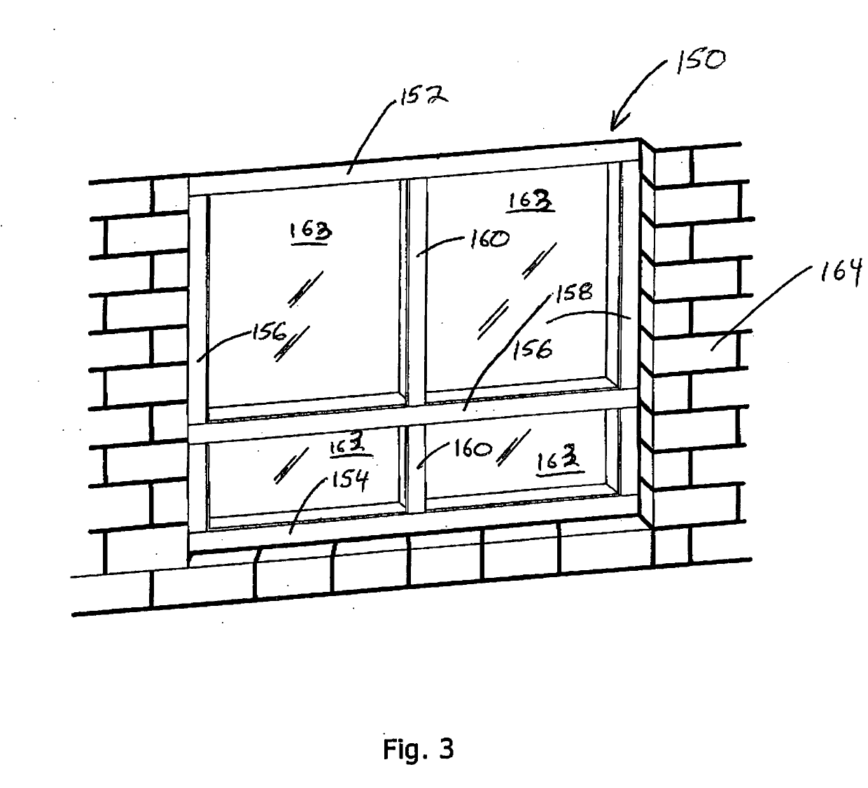

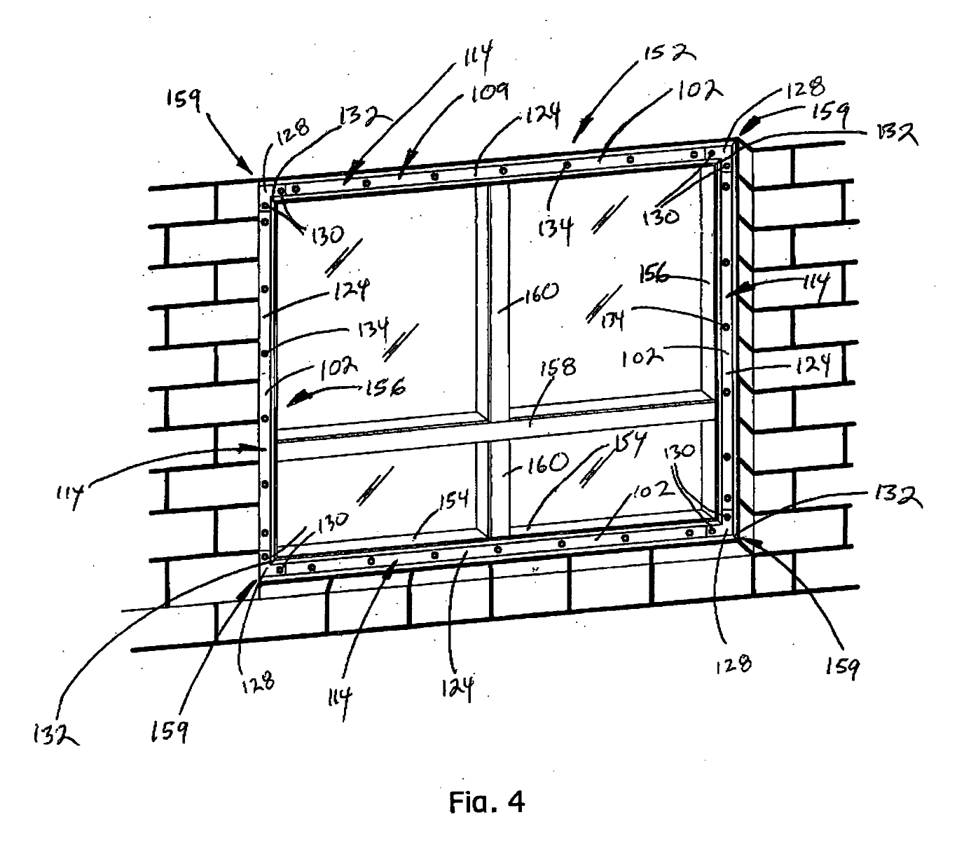

The apparatus for cladding window elements may also include at least one thermal break disposed at least in part along at least one of the cover 102, the first seal, and the second seal. For example, an inner thermal break 112 may be disposed between the cover 102 and a window pane support member. The inner thermal break 112 as shown in FIG. 1 is attached to cover back 125 by an adhesive layer 111 applied to the bottom of inner thermal break 112 for application against cover back 125. Inner thermal break 112 may be made of EPDM closed cell foam, although other types of foam or other material with low temperature conducting compressible material may suffice. Although such foam or other material may be compressible to give more flexibility in seating gaskets against window pane surfaces, the said material need not be compressible if cladding 100 has been constructed to allow bulb 118 or other gaskets, to deform to some degree when cover 102 is installed. If inner thermal break 112 is constructed of compressible material, this also provides a tolerance for some unevenness in faces 157, 161, through warping, improper installation, or otherwise. The adhesive layer 111 on the back of inner thermal break 112 may be in the form of a self adhesive strip with a protective back (not shown) that, when removed, reveals an adhesive surface that may then be applied longitudinally against cover back 125 to hold inner thermal break 112 securely in position while cladding 100 is installed on a window frame or a window mullion (shown in FIG. 3). It is to be understood that other ways of bonding foam or other low temperature conducting material to a metal surface, usually aluminum, which would be known by one skilled in the art, would suffice. The cladding need not necessarily be made out of metal, but may be made of other suitable materials such as plastic, which would be known by those skilled in the art.

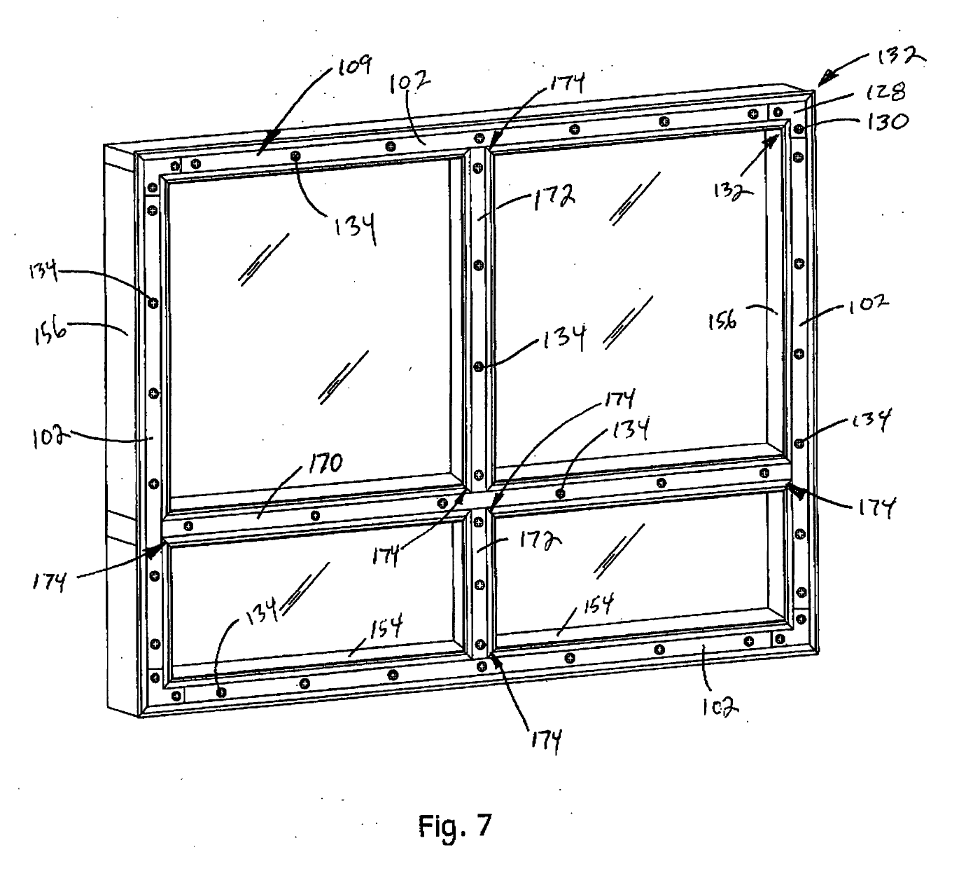

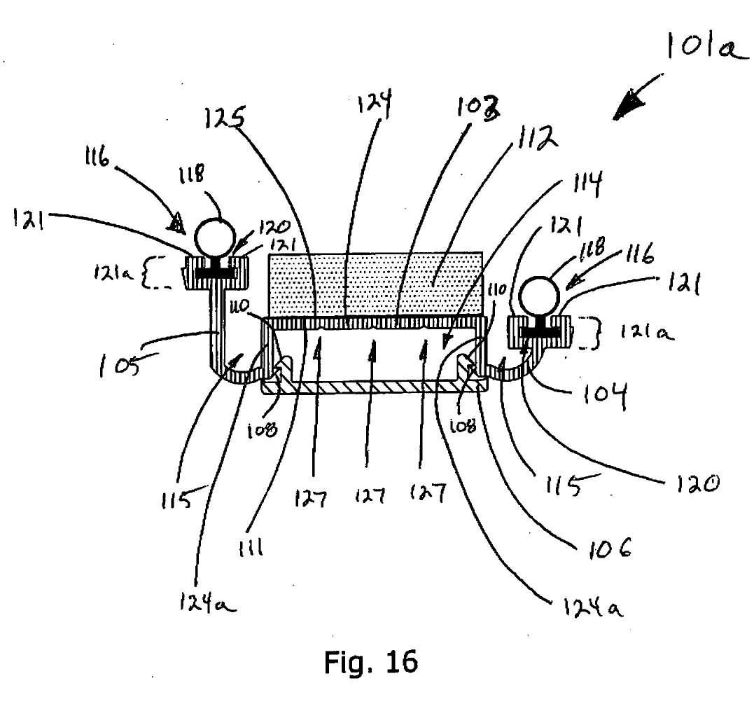

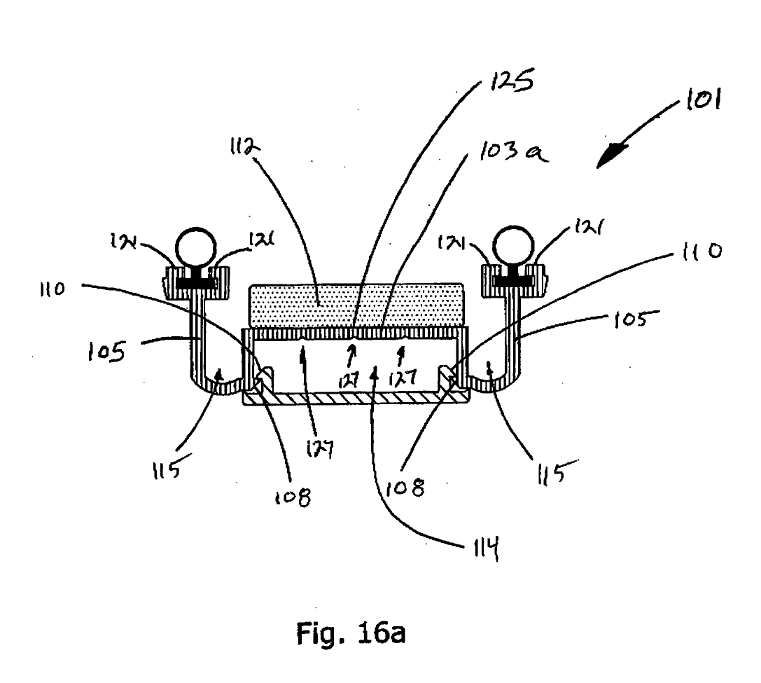

By another approach, inner thermal break 112 may be bonded to a window frame or a window mullion on site by a self adhesive strip or otherwise. Cladding 100 may then be attached to a window frame 152, 154, 156 or window mullion 158, 160 (shown in FIG. 3) by cover mounting screws 134 as shown in FIG. 7. Cover bottom 124 may have pre-drilled apertures (not shown) for accepting said cover mounting screws 134. Alternatively, cover mounting screws 134 may constitute self tapping screws to make holes in cover bottom 124 in positions compatible to the window frame or window mullion against which cladding 100 is to be installed. Cover bottom 124 may also have several rows of screw starting notches 127 (shown in FIG. 16) to aid in attaching self tapping cover mounting screws 134 in desired positions into a window frame or window mullion (not shown). It is anticipated that mounting inner thermal break 112 on cover back 125 during manufacture of cladding 100 would be a time efficient way of installing inner thermal break 112. While cover 102 could be connected directly against a window frame or window mullion (not shown), this arrangement may conduct unnecessary heat or cold from window cladding 100 to the window frame or window mullion (not shown), especially when window cladding 100 is made of aluminum or other metal and the window frame and window mullions are also made of aluminum or other metal. Accordingly, inner thermal break 112 is not required for a water resistant seal against panes of glass, but inner thermal break 112 is recommended to guard against unnecessary heat or cooling loss and/or frost or condensation.

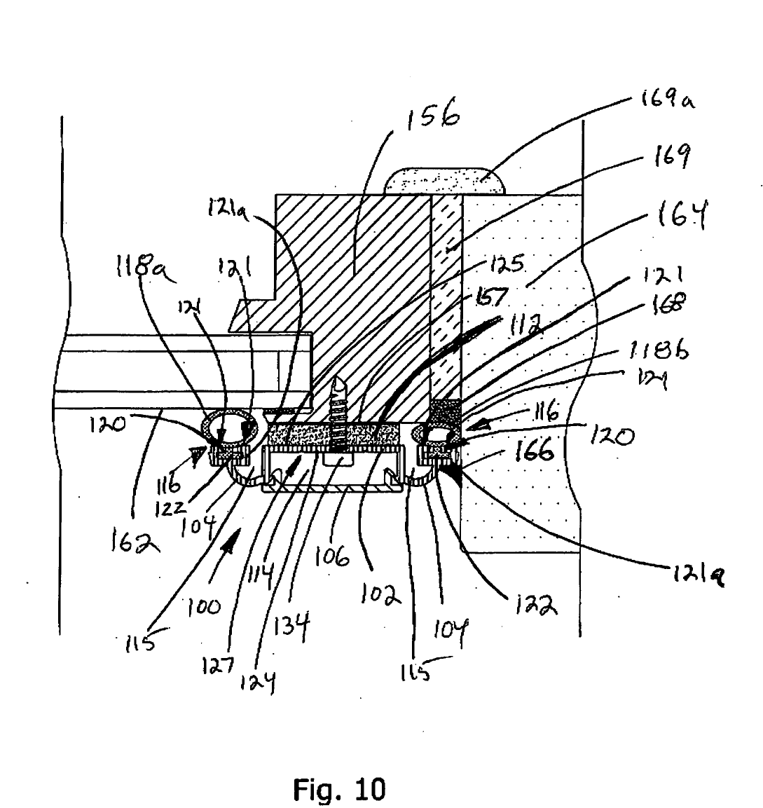

By yet another approach, cover 102 may be installed on a frame or mullion leaving a gap or air pocket between frame face 157 or mullion face 161 (both not shown) and cover back 125, creating an air thermal break between opposing gaskets 116 when bulbs 118 are compressed against the exterior surface of panes 162 (not shown). If such a gap or air pocket is used, same may comprise part of side thermal breaks 115 as shown in FIG. 10.

The inner and outer thermal breaks 112, 114 are not required to seal a mullion 158, 160 or frame 152, 154, 156 from water running along a pane of glass. Many different profiles of covers, including a simple flat piece of profile material, could be attached to a frame or mullion by screws, bonding or other means, wherein a gasket (not shown) could be compressed between a back surface of the profile material and an outer surface of a window pane 162 to seal the glass. If the profile material is first attached to a mullion or frame, the gasket need not even be fixedly attached to the profile material, in that a gasket could be compressed to fit between the back surface of the profile material and the outer surface of the window pane 162. For ease of installation and to ensure that the gasket stays in place and to ensure the gasket lies against the glass in a substantially straight manner for aesthetics, gasket 116 or other gasket serving a similar purpose, which would be known to those skilled in the art, would usually be attached to the underside of profile material (not shown) during manufacture. While it is recognized that gaskets could be securely bonded to the back of a piece of profile material under controlled factory conditions, the use of a structure for physically holding gasket 116 (not shown) against a back surface of profile material (not shown), such as gasket retaining track 120, provides the flexibility for inserting different sizes of gaskets, both during manufacture and during installation on site if necessary or desirable. In some cases, as will be seen below, it will be desirable to have different sizes of gasket along a run of profile material, which would significantly complicate attaching a run of gasket material in a straight line along the said profile material without a track or other holding and aligning means.

While a gasket retaining head element 122 could be glued into position in gasket retaining track 120 to ensure proper positioning of the gasket, especially where different size gaskets are used along a length of profile material, gasket retaining head element 122 may be removably or fixedly attached in or to gasket retaining track 120 via a slight friction fit. Such a friction fit would avoid the additional step and cost of gluing and would retain the possibility of easily replacing gasket material during installation of cladding 100 in the event that a particular window being cladded deviates from the standard window size for a particular building, therefore requiring on site gasket modifications. For this purpose, an installer could be supplied with a kit of different sizes of gaskets that could be inserted into gasket retaining track 120 as needed and as more particularly set out below. Bulb gasket 116 is a reliable way of ensuring sufficient pressure against a pane of glass to resist water from traveling between the glass and the gasket. Deformable bulb 118 of bulb gasket 116 is compressed between an outer window pane surface 162 (not shown) and gasket compression surface 121 of gasket compression head 121a, which could be a part of, or attached to, cover bottom 124, or gasket compression head 121a could be held in position over a pane of glass by other means such as by arms 104. One of arms 104 may be elongated to form arm 105 as shown in FIG. 16 to accommodate panes of glass recessed at different depths from the front surface 157, 161 of a window frame 152, 154, 156 or window mullion 158, 160 (not shown in FIG. 1 and FIG. 16), where one of two cover gaskets can not compress enough to allow the other gasket to compress against a frame, mullion or pane gasket with compression surfaces of equal depth and gaskets of equal size, or where gaskets of different sizes cannot adequately compensate for the difference in window pane surface 162 depths. Alternatively, two elongated arms may be used, such as over a mullion with adjacent recessed pane surfaces 162 of equal depths on either side of the mullion as shown in FIG. 16a, or where the difference in recessed depths of the window pane surfaces are sufficiently similar to permit the use of a cover with arms of equal recessed lengths with suitable different sized gaskets.

The space bounded by arms 104 or 105, gasket compression head 121a, bulb 118 (not shown), window pane surface 162, inner thermal break 112, and cover wall 124a comprise size thermal breaks 115. Side thermal breaks 115 may have different boundaries depending upon the construction of cladding. For instance, where air is used for thermal break 112, inner thermal break 112 and side thermal breaks 115 may comprise one thermal break.

FIG. 2 is a fragmented perspective view of a strip of cover 102 of cladding 100 with cladding corner cut 132 cut at a 45 degree angle to join two covers 102 at a 90 degree or perpendicular angle over frame corners 159 as shown in FIG. 4. Said covers 102 may be held together at frame corners 159 by corner key 128 having perpendicular corner key legs 128a. The corner key legs 128a are attached to covers 102 in outer thermal breaks 114 under cover teeth 108, thereby leaving corner key clearance 126 between the bottom of cover teeth 108 and the top surface of corner key 128 to accommodate cap teeth 110 of cap 106 (not shown). Cap 106 is snapped onto cover 102 to form outer thermal break 114 after cover 102 is attached to a window frame face 157 (not shown). Corner key 128 may be attached flushed to cover bottom 124 through corner key apertures 129 by corner key mounting screws 130. Corner key mounting screws 130 typically do not project much beyond cover backs 125 (not shown) to allow inner thermal breaks 112 (not shown) to compress against window frame faces 157 without corner key mounting screws 130 restricting much of the compression of inner thermal breaks 112 caused when covers 102 are attached to frame faces 157 by cover mounting screws 134. While corner keys 128 may be installed in covers 102 at frame corners 159 during installation on site, corner keys 128 are usually attached to covers 102 during manufacture when cladding 100 would be manufactured for multiple windows of similar size and structure due to the greater precision available in the manufacturing process. FIG. 2 shows corner keys 128 being installed by corner key mounting screws 130 mounted through corner key apertures 129. It is to be recognized that fasteners such as self tapping screws could make their own apertures in cover bottoms 124 of covers 102.

Corner keys 128 may be attached to covers 102 by screwing, bolting, riveting, welding, glueing, bonding, friction, or by other ways known in the art. Window frame cover assembly 109 may be made without corner keys 128, such as by welding covers 102 along cladding corner cuts 132 at frame corners 159. By another approach, covers 102 may be installed on frame 152, 154, 156 on site, with or without corner keys 128. Covers 102 for horizontal mullion 158 and vertical mullions 160 may also be welded or otherwise attached to cover assembly 109, although covers 102 for mullions 158, 160 would usually be mounted separately to retain the ability to accommodate window manufacturing differences.

Bulb gaskets 116 (not shown), gasket retaining head elements 122 (not shown) mounted in gasket retaining tracks 120 and in particular bulbs 118 (not shown) would typically also be cut at 45 degrees at frame corners 159 along the planes of corner cuts 132 so that bulb gaskets 116 (not shown) of two perpendicularly mated pieces of cover 102 may also meet at a 45 degree angles at frame corners 159.

FIG. 3 is a perspective view of a simple prior art aluminum window 150, with no moving sash and no window sill, shown attached to a building wall 164. Window 150 has a frame head 152, frame sill 154, frame jambs 156, horizontal mullion 158 and vertical mullions 160 defining cavities comprising window panes 163.

FIG. 4 is a perspective view of a window frame cover assembly 109 attached to window 150 of FIG. 3 without mullion covers 102. Window frame cover assembly 109 comprises four pieces of cover 102, each of the two ends of each of the four pieces of cover 102 having a 45 degree cladding corner cut 132 at each of four frame corners 159 for forming a rectangular window frame cover assembly 109 joined at frame corners 159 by corner keys 128 held against cover bottoms 124 by corner key mounting screws 130. The window frame cover assembly 109 itself is attached to upper frame head 152, frame sill 154 and frame jambs 156 by cover mounting screws 134 mounted through cover bottoms 124 of covers 102. Cover mounting screws 134 mounted through cover bottoms 124 are mounted through pre-made apertures in cover bottoms 124 or through apertures made by cover mounting screws 134 comprising self tapping screws. Heads of cover mounting screws 134, or other fasteners, have a depth shallow enough not to interfere with cap 106 (not shown) being snapped onto covers 102 by means of cover teeth 108 and cap teeth 110 (not shown). The width of the heads of cover mounting screws 134 are similarly sized not to inhibit the entry of cap teeth 110 into corner key clearances 126 (not shown) of outer thermal breaks 114 to engage cover teeth 108.

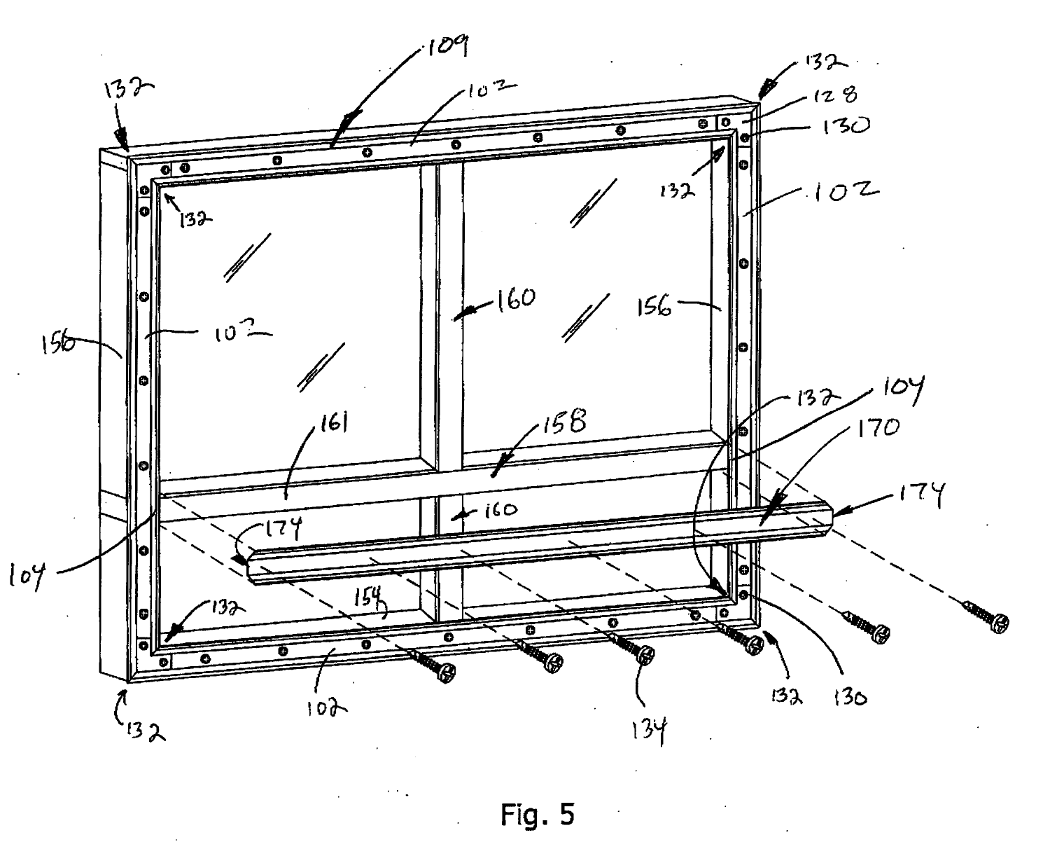

FIG. 5 shows the window frame cover assembly 109 of FIG. 4 together with horizontal mullion cover 170 having contoured cover ends 174 for engaging the sides of covers 102 of frame jambs 156, and in particular arms 104 of covers 102 of frame jambs 156. Cover mounting screws 134 are used to attach horizontal mullion cover 170 to the horizontal mullion face 161 of horizontal mullion 158.

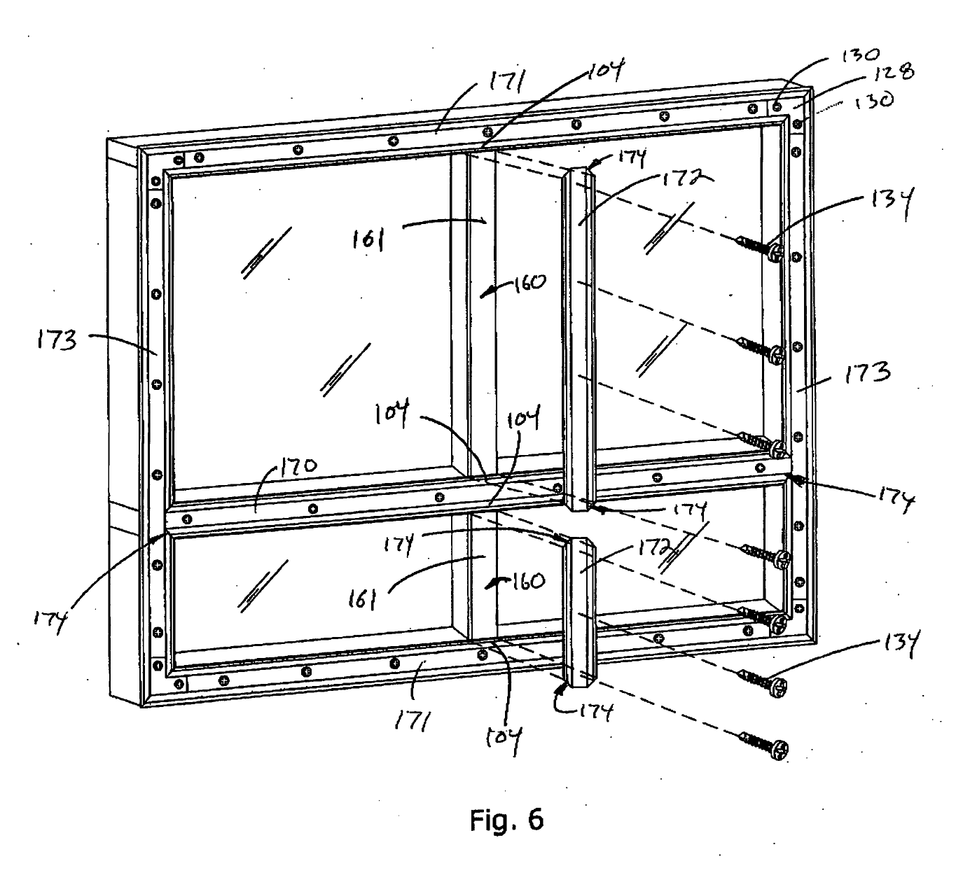

FIG. 6 is an exploded perspective view of vertical mullion covers 172 having contoured ends 174 for engaging the sides of horizontal frame covers 171 and sides of horizontal mullion cover 170 and in particular, arms 104 of said sides of covers 171, 170. Vertical mullion covers 172 are attached by cover mounting screws 134 to vertical mullion faces 161 of vertical mullions of 160.

FIG. 7 is a perspective view of window frame cover assembly 109 and horizontal mullion cover 170 and vertical mullion covers 172 as attached to window 150 by cover mounting screws 134.

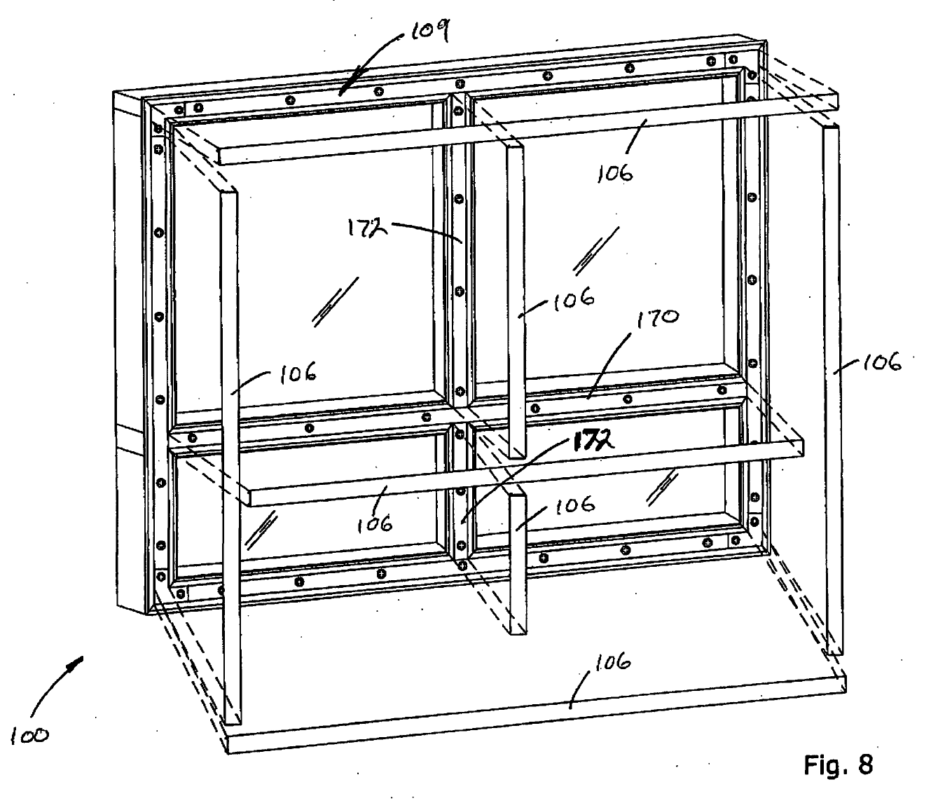

FIG. 8 is an exploded view of caps 106 of window frame cover assembly 109 and mullion covers 170, 172.

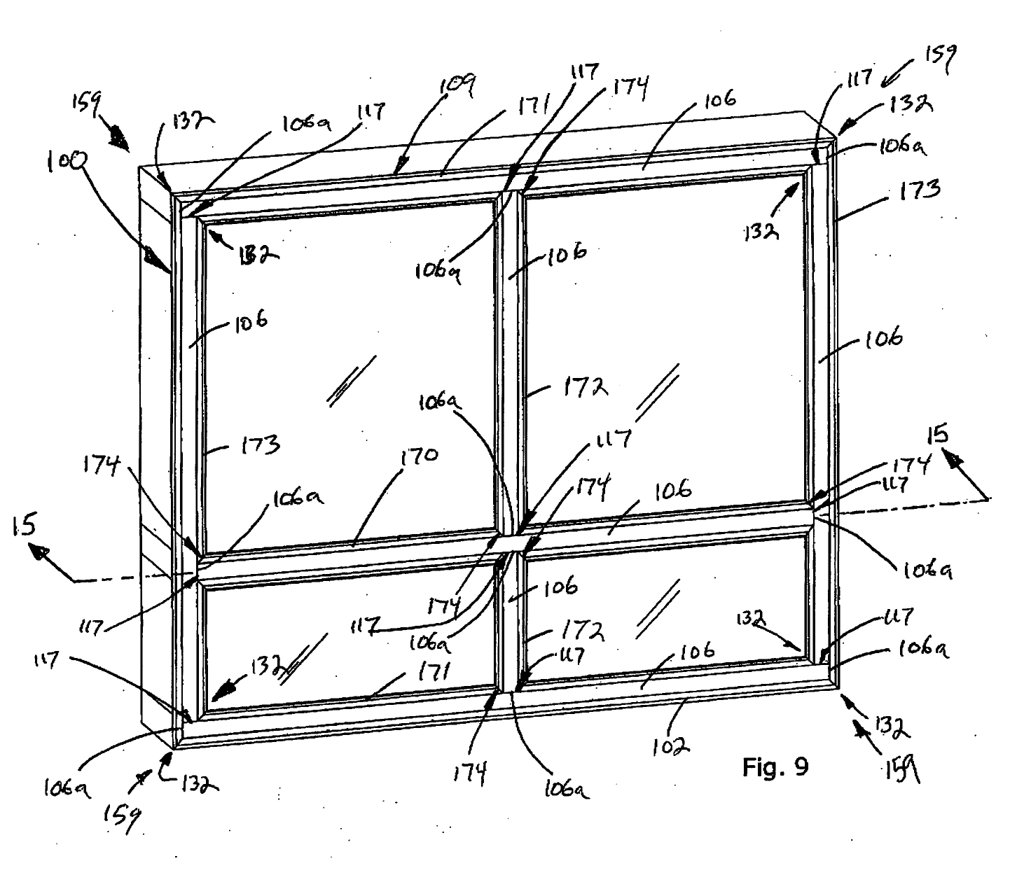

FIG. 9 is a perspective view of cladding 100 of FIG. 8 showing caps 106 on horizontal frame covers 171, vertical frame covers 173, horizontal mullion cover 170 and vertical mullion covers 172. Caps 106 may have cap ends 106a cut at right angles to the longitudinal axis of caps 106. Cap ends 106a of caps 106 for horizontal frame covers 171 may abut outside cover walls 136 of vertical frame covers 173. Cap ends 106a of cap 106 for horizontal mullion cover 170 may abut inside cover walls 138 of vertical frame covers 173. Caps 106 provided with ends 106a at right angles to the longitudinal axis of caps 106 for vertical mullion covers 172 abut inside cover walls 138 of horizontal frame covers 171 and one of the cover walls 124a of horizontal mullion cover 170. Whether cap ends 106a of a cap 106 of a mullion abuts a cover wall 124a of a frame cover 171, 173 or a mullion cover 170, 172 depends upon the number and placement of mullions 158, 160.

It is to be recognized that caps 106 may also be cut at 45 degree angles at frame corners 159 along the planes defined by cladding corner cuts 132. Other ways of mating caps 106 at cap junctions 117 would also be known by those skilled in the art.

FIG. 10 is a fragmented horizontal sectional top view of window frame jamb 156 with cladding 100 attached thereto. Cladding 100 is attached to frame jamb 156 by cover mounting screws 134 such that the bottom of inner thermal break 112 is in contact with frame face 157 of frame jamb 156 and top surface of inner thermal break 112 is in contact with cover back 125 of cover 102. Inner thermal break 112 may, but need not, be in a state of compression caused by fastening means such as cover mounting screws 134. Bulb 118a of bulb gasket 116 is in slight compression, bulb 118a being compressed between gasket compression surfaces 121 of gasket compression head 121a, the two portions of gasket compression surface 121 being separated by gasket retaining track 120, and the outer surface of window pane 162. Gaskets 116 are held in gasket retaining tracks 120 by gasket retaining head elements 122. Opposing bulb gasket 116 shows bulb 118b in a greater state of compression than bulb 118a as frame face 157 and abutting old window sealing material such as caulking 168 between frame jamb 156 and building wall 164 are further outwards towards the exterior of the building than the exterior outer surface of window pane 162. Although the two bulbs 118a, 118b of cladding 100 may be compressed equally, they need not be. Bulb 118b, regardless of the precise degree of compression, may have some difficulty making a complete seal against frame jamb 156 and/or old caulking 168 if these elements are damaged or extremely weathered. Where it is known that frame jambs 156 (or head 152 or sill 154) and/or old caulking 168 are significantly uneven or out of an abundance of caution, new caulking 166 may be installed after installation of cladding 100, between building wall 164 and cladding 100, typically over gasket compression head 121a. The installation of cladding 100 and new caulking 166 should not affect detrimentally insulation 169 and trim 169a used to seal the gap between window frame jamb 156 and building wall 164. Window frame 152, 154, 156 are attached to building walls 164 in a conventional manner by screws, nails, or the like. Cover arms 104 projecting from the outside ends of cover walls 124a provide a pleasing profile for cover 102 and allow gasket compression surfaces to be at different depths relative to cover back 125. Arms 104 also provide for side thermal breaks 115.

FIG. 11 is a fragmented horizontal sectional top view of vertical window mullion 160 with cladding 100 over vertical mullion face 161. Cladding cover 102 seals inner thermal break 112 against vertical mullion face 161 by means of cover mounting screws 134. Bulbs 118a are compressed not only against the outer surface of window panes 162 but may, but need not, also compress against exterior mullion sides 161a.

FIG. 11 also shows horizontal mullion cover 170 mounted on horizontal mullion 158 (not shown). Vertical mullion cladding 100 overlies upper bulb gasket 116 of horizontal mullion cover 170. FIG. 11 shows the use of a continuous horizontal bulb 116 gasket with bulb 118a compressed against the outer surfaces of window panes 162 yielding compression depth 178, and with bulb 118b being compressed to gasket thickness 180 where upper horizontal bulb 118b is compressed between upper horizontal gasket compression head 121a and front surface of 161 of vertical mullion 160. Where horizontal bulb 118a transitions from compression depth 178 to compression depth 180, gasket compression gap 176 is created which is defined by the surface of transitioning bulb 118a, 118b, mullion side 161a and outer window pane surface 162. Gasket compression gap 176 may be filled with caulking or other sealant to prevent moisture from reaching horizontal mullion 158 (not shown) between bulb 118a, 118b and outer window pane surface 162.

FIG. 11a is similar to FIG. 11 except that the means of minimizing or eliminating water seepage between horizontal bulb 118a, 118b and exterior window pane surface 162 is different. Upper horizontal bulb 118a, 118b is provided with gasket relief 182 by cutting horizontal bulb 118a, 118b where gasket depth 178 changes to gasket depth 180 at mullion sides 161a. Gasket relief 182 may comprise cutting bulb 118a, 118b so that bulb segment 183 may be compressed to depth 180 where it is compressed between upper horizontal gasket compression head 121a and mullion face 161 and bulb segments 183 may be compressed to a different depth 178 between upper horizontal gasket compression head 121a and the outer surfaces of window panes 162. Gasket relief 182 may be a straight cut or may have a gasket relief extension 182a of a different direction. Alternatively, gasket relief 182 and gasket relief extension 182a may be curved or of some other configuration to more precisely seal bulb segments 183 against exterior window pane surfaces 162 to minimize or eliminate gasket compression gap 176. The bottom end of vertical bulbs 118a of vertical mullion cover 102 may be formed or cut to mate with the sides of horizontal bulbs 118a to minimize or eliminate water from reaching vertical mullion 160 at the bulb junction 119 of vertical bulbs 118a and horizontal bulbs 118a. As before, FIG. 11a shows inner thermal break 112, outer thermal break 114 and side thermal breaks 115.

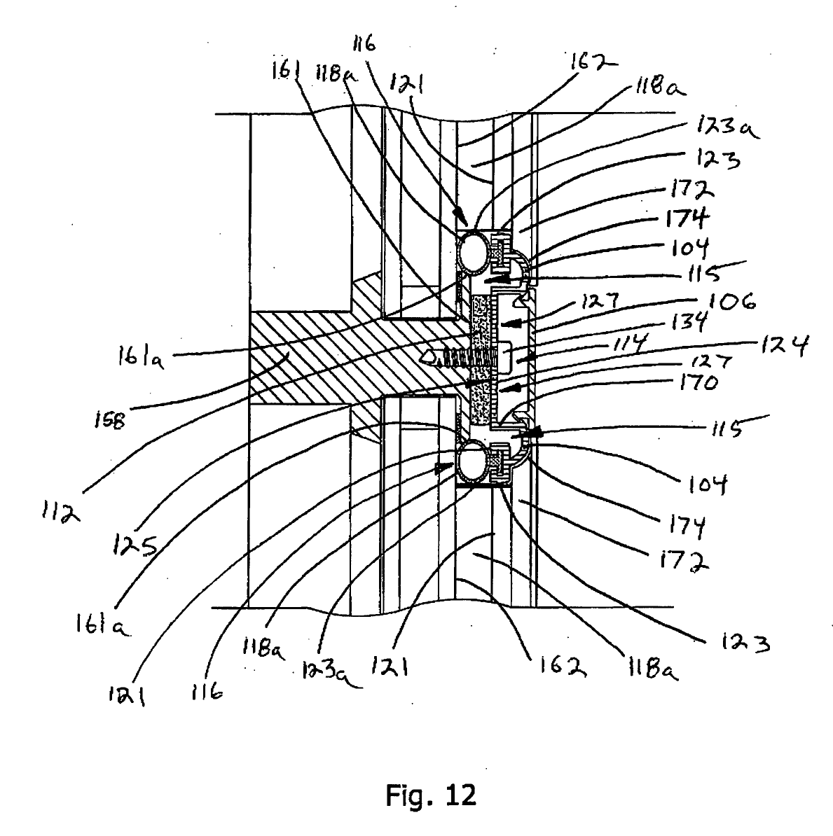

FIG. 12 is a fragmented vertical sectional view of horizontal window mullion 158 with cladding 100 thereon. Vertical gasket ends 123a may be curved to conform to the curvature of the top surface of horizontal bulb 118a. In other approaches, gasket end 123a may be straight or of some other shape. Gasket ends 123a may extend past track ends 123.

It will be recognized by those skilled in the art that gasket ends 123a may be oriented with respect to horizontally or vertically oriented bulbs 118a, depending on whether horizontal mullion covers 102 or vertical mullion covers 102 are installed first.

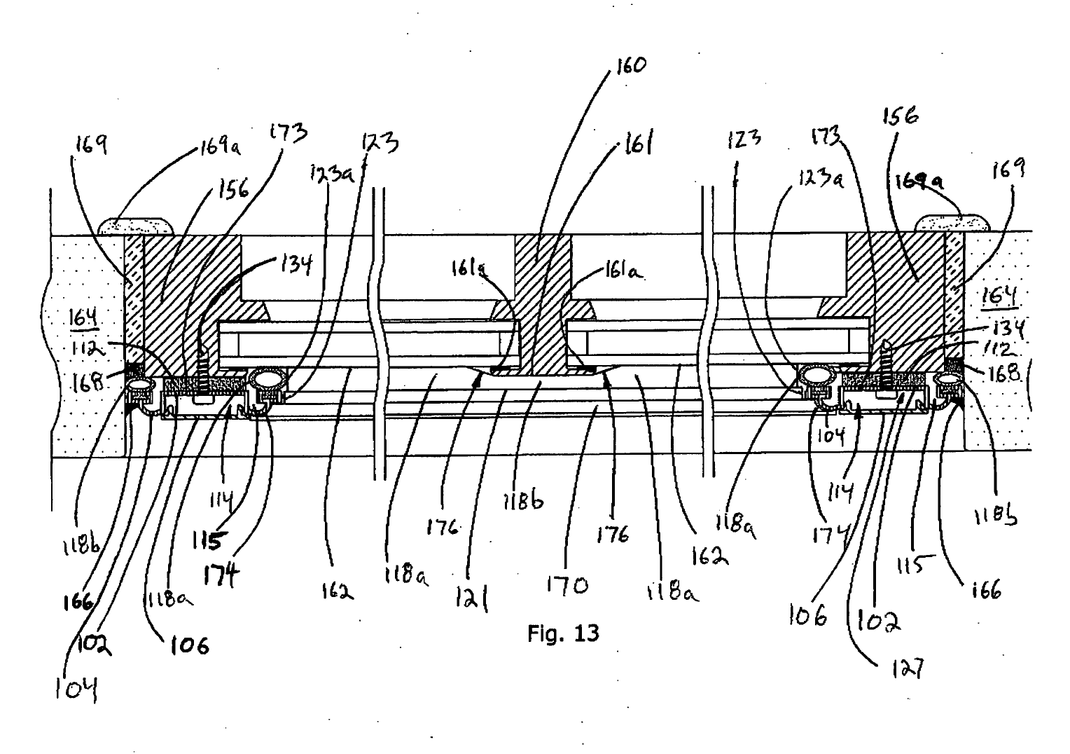

FIG. 13 is a horizontal sectional top view of a window with vertical frame cladding but with vertical mullion cladding removed to better show horizontal mullion cladding in the background. FIG. 13 shows a continuous upper horizontal bulb 118a, 118b showing gasket compression gap 176 where gasket portions 118a may rest against exterior window pane's 162 transition to gasket portion 118b, which is compressed against vertical mullion face 161 of vertical mullion 160 (also shown in FIG. 11). The ends 123a of upper horizontal bulb 118a meet with inner vertical bulbs 118a of vertical frame covers 173.

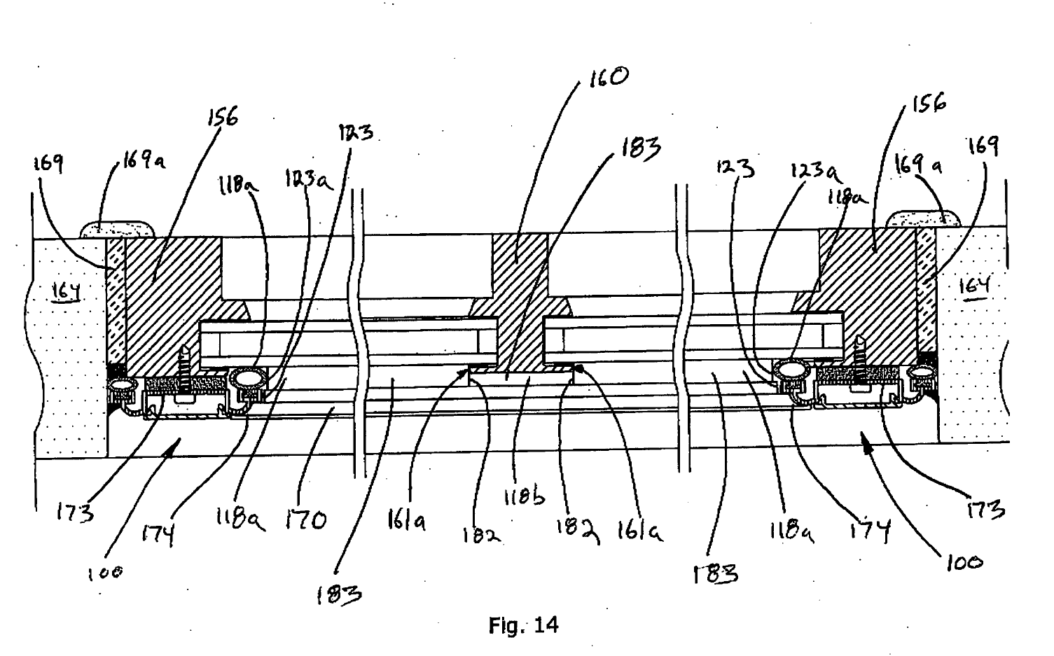

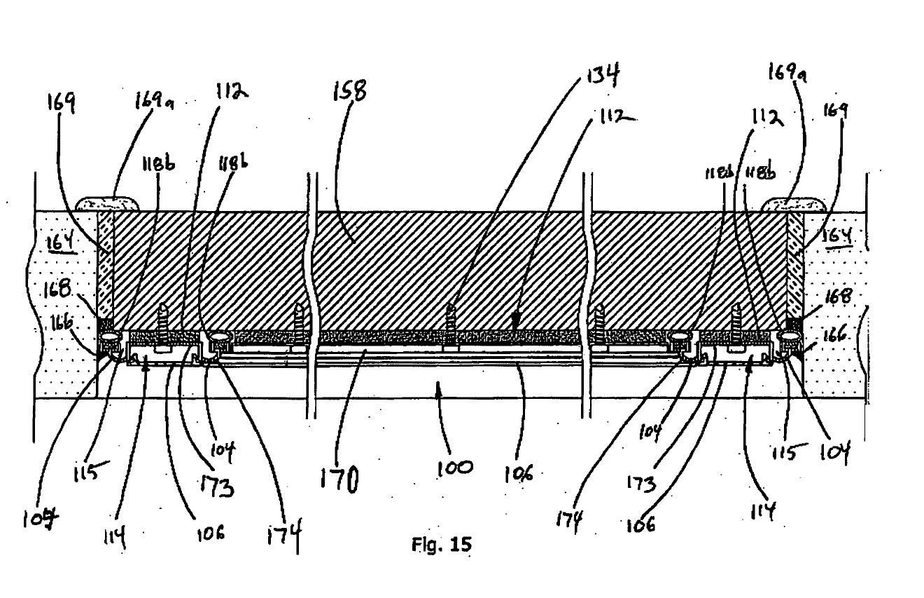

FIG. 14 also shows vertical frame cladding 100 on frame jambs 156 as well as gasket ends 123a of upper horizontal mullion gasket bulb 118a where said gasket ends 123a mate with inner vertical bulbs 118a of vertical frame covers 173. As in FIG. 13, FIG. 14 shows horizontal mullion cover 170 in the background with vertical mullion cladding removed for clarity. FIG. 14 shows gasket reliefs 182 where gasket compression changes thus allowing gasket 118b compressed against mullion face 161 of vertical mullion 160 to immediately release gasket portions 118a to compress against outer window pane surfaces 162 without creating gasket compression gap 176.

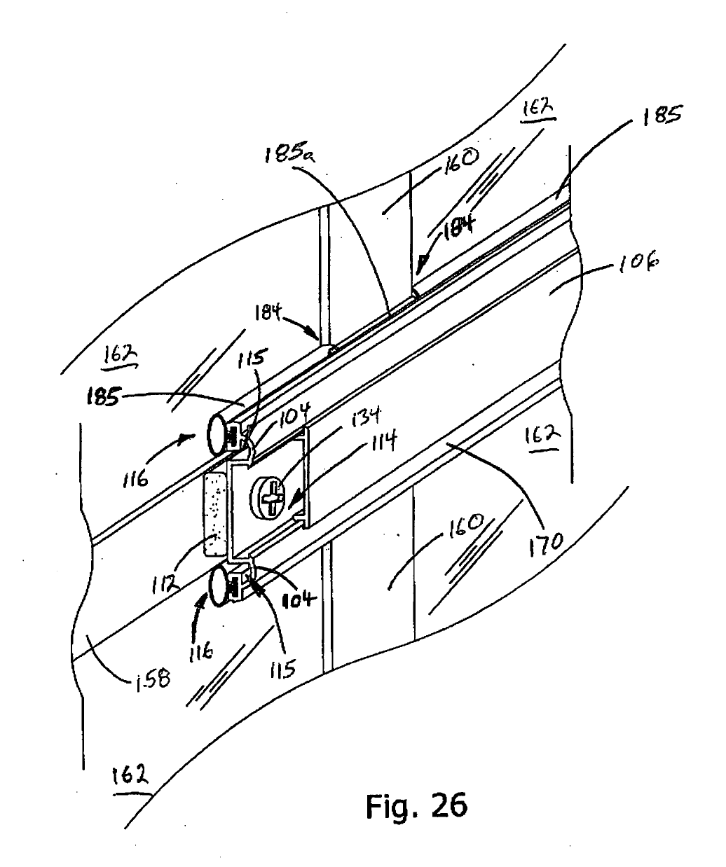

Even with gasket relief extensions 182a (not shown), if desired, bulb segments 183 between reliefs 182, 182a, namely bulbs 118a, 118b, will be in different states of compression. Occasionally, bulb 118b, when under greater compression than bulb 118a, may have to deform to such an extent that bulb 118b may not deform enough to allow bulbs 118a to compress against outer window pane surfaces 162 or to allow cover back 125 of cover 102 to be mounted close enough to mullion face 161 or frame face 157. As shown in FIG. 26 and FIG. 26a, different sizes and profiles of gasket segments 185, 185a may be used between gasket divisions 184, where divisions 184 will typically occur substantially where gasket reliefs 182 would be required or desirable.

FIG. 15 is a horizontal sectional top view of window cladding 100 of FIG. 9, taken along line 15-15 of said FIG. 9, wherein the cladding 100 is shown relative to a building wall 164. FIG. 15 shows horizontal mullion cover 170 in section and showing inner thermal break 112 of horizontal mullion cladding 100 installed on horizontal mullion 158 by cover mounting screws 134. FIG. 15 further shows contoured cover ends 174 of horizontal mullion cover 170 and cap 106 of horizontal mullion cover 170 overlapping inner arms 104 of vertical frame covers 173. Bulb gaskets 118b of each vertical frame cladding are shown in substantially similar states of compression.

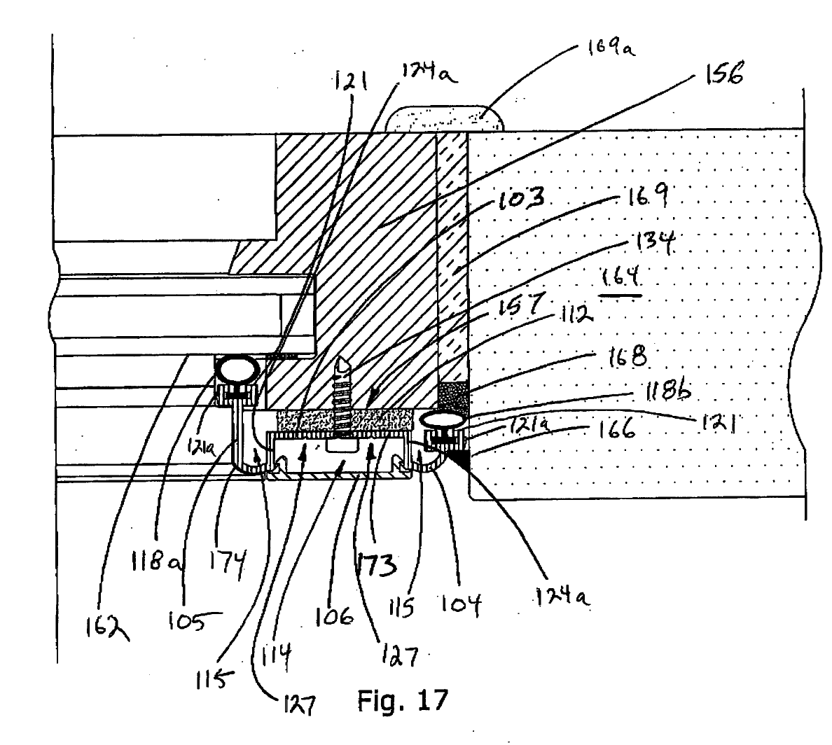

FIG. 16 shows asymmetrical cladding 101a with one short or standard arm 104 and one elongated arm 105. As shown in FIG. 17, sometimes the difference in depth between frame face 157 or mullion face 161 (not shown) and the depth outer of window pane surface 162 is so great that symmetrical cladding 100 with two arms 104 of equal size will not accommodate the additional depth of the exterior window pane surface 162 regardless of size and type of gasket without compromising water resistance, durability or esthetics. In such circumstances, asymmetrical cladding 100a with one arm longer than the other may be used. Regardless of the length of arms 104 and 105, bulbs 118a and 188b, if bulb gaskets 116 are used, may be in different degrees of compression.

FIG. 16 and FIG. 17 also show screw starting notches 127. Three parallel screw starting notches 127 run the longitudinal length of cover 103 (or covers 102, 103a) with elongate arm 105. FIG. 17 shows two such parallel screws starting notches 127 with the center screw starting notch 127 (not shown) on FIG. 16 used to mount cover mounting screw 134 of FIG. 17. Notches 127 are optional, especially if apertures in cover bottom 124 (not shown) are to be provided during manufacture. However, screw starting notches 127 allow cover mounting screws 134 to be mounted at consistent distances from cover walls 124a, thus more precisely controlling where mounting screws will enter the window frame or mullion to which cladding 100, 100a, 101 is to be attached. Screw starting notches 127 may be supplied on cover bottoms 124 regardless of the length of arms 104, 105.

FIG. 16a shows cladding 101 with two elongate arms 105, which bring gasket compression surfaces 121 of each arm 105 below cover back 125. The length of elongate arms 105 will depend upon the size of gaskets used and the difference in depth between mullion faces 161 (not shown) and outer window pane surfaces 162 (not shown). Cladding with elongate arms 103a is mostly for use over horizontal and vertical mullions 158, 160, where outer window pane surfaces 162 are significantly set back from mullion faces 161 (not shown).

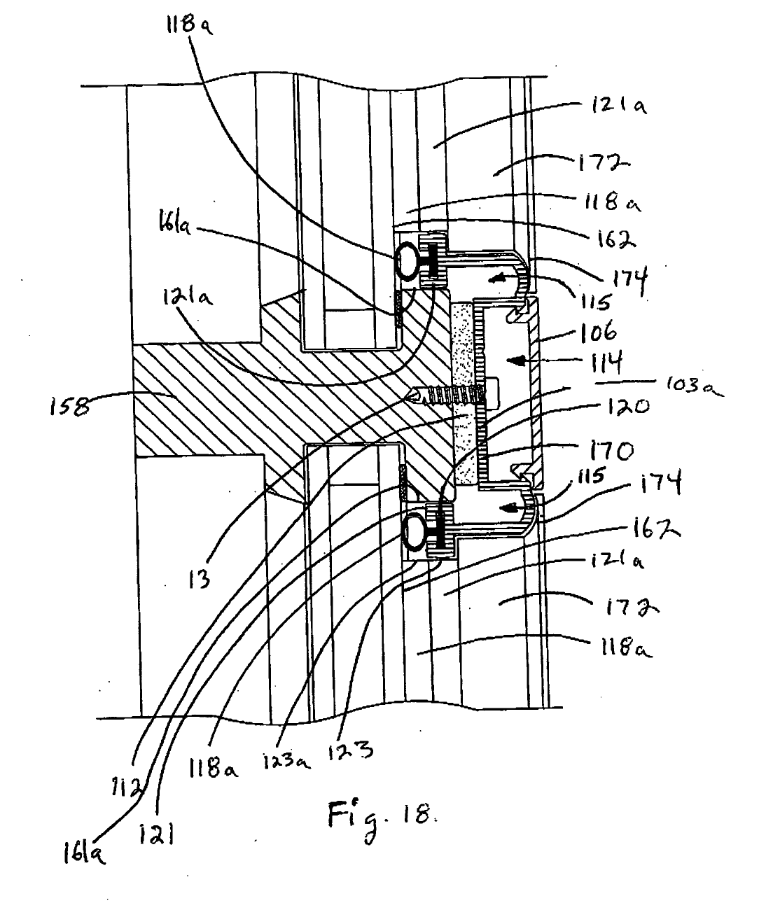

FIG. 18 is a fragmented sectional side view of cladding 101 with elongate arms 105 as installed on a horizontal mullion 158 with recessed adjoining window panes surfaces 162.

Notwithstanding the juxtaposition of gasket compression heads 121a in relation to horizontal mullion sides 161a as shown in FIG. 18, neither gasket compression head 121a nor elongate arms 105 or any other metal part of cladding 101 will generally be in direct contact with mullion sides 161a in order to maximize the benefit of the various thermal breaks and in particular, side thermal breaks 115, to prevent the direct transfer of cold or heat from the outside surface of cladding 100, 100a, 101 directly to mullions 158, 160. Accordingly, a small gap will usually be provided between cover 103a (or 102, 103) and mullion sides 161a.

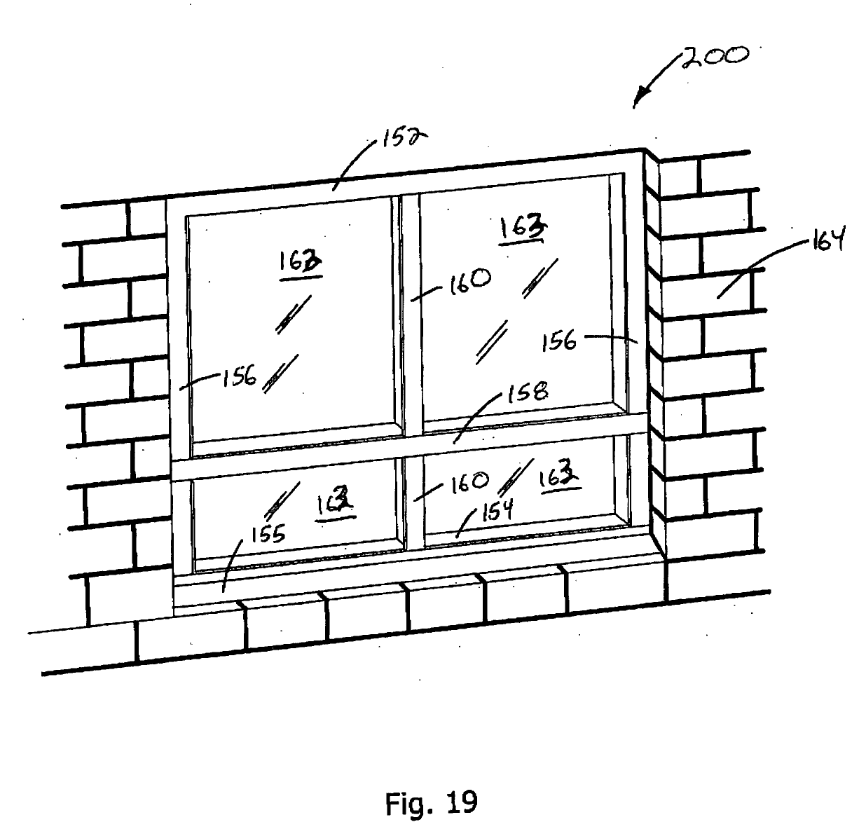

FIG. 19 is a perspective view of a prior art aluminum window 200 with sill projection 155. Window 200, as in prior art window 150, has upper frame head 152, side frame jambs 156 and frame sill 154. Window 200 may also have horizontal mullions 158 and vertical mullions 160, said head, sill jambs, and mullions defining openings for window panes 163.

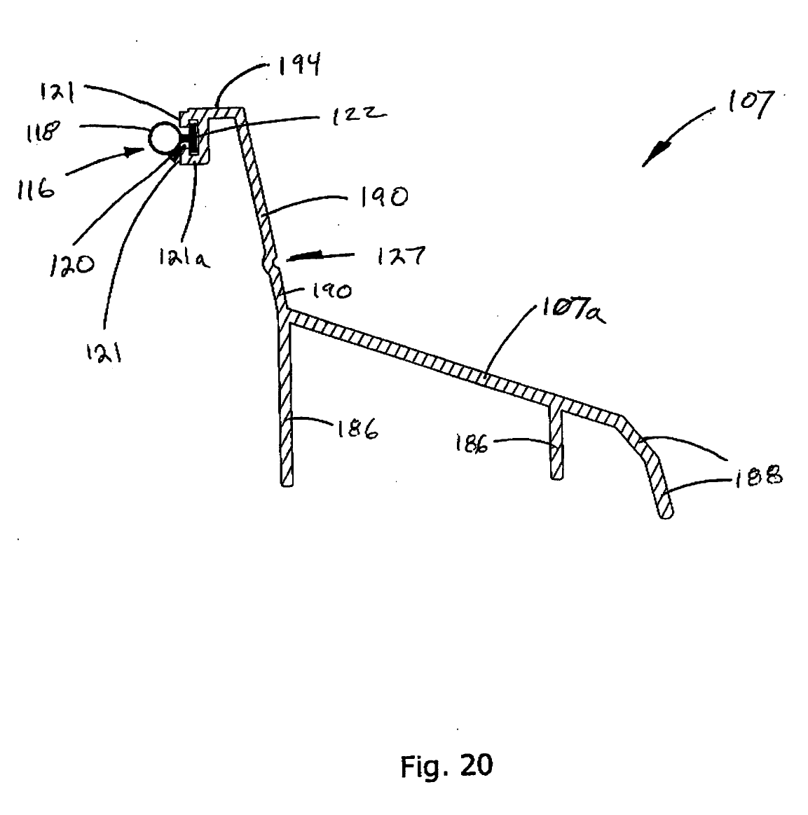

FIG. 20 is a sectional side view of sill cladding 107 comprising a seal compression head such as gasket compression head 121a, supporting a sill cladding seal, such as gasket 116. A sill cover riser 190 extends from the seal compression head to a sill cover 107a, the sill cover riser 190 configured to be attachable to at least one window pane support member such that the sill cladding seal provides a substantially water resistant seal against at least one of a window pane, a vertical window pane support member, and a window sealing material. The sill cover 107a (usually angled) extends over at least a part of a window sill and transitions into sill cover overhang 188 that is configured to extend past an edge of the window sill. For example, the sill cover overhang 188 may overhang the bottom of window opening 164a in building 164 (not shown) to direct water past the opening. The upper end of sill cover 107a transitions into sill cover riser 190, which at its upper end extends horizontally towards a window (not shown) mating surface 194 for mating with horizontal ends 175 (not shown) of vertical frame covers 173 and vertical mullion covers 172 (not shown). The distal end of mating surface 194 terminates at gasket compression head 121a containing gasket retaining track 120, which in turn holds gasket retaining head element 122 of bulb gasket 116. Bulb 118 will be compressed against gasket compression surfaces 121 upon installation against outer window pane surfaces 162 (not shown). Sill cladding 107 will be supported by one or more sill cladding support legs 186, which may be attached to the bottom surface of angled sill cover 107a.

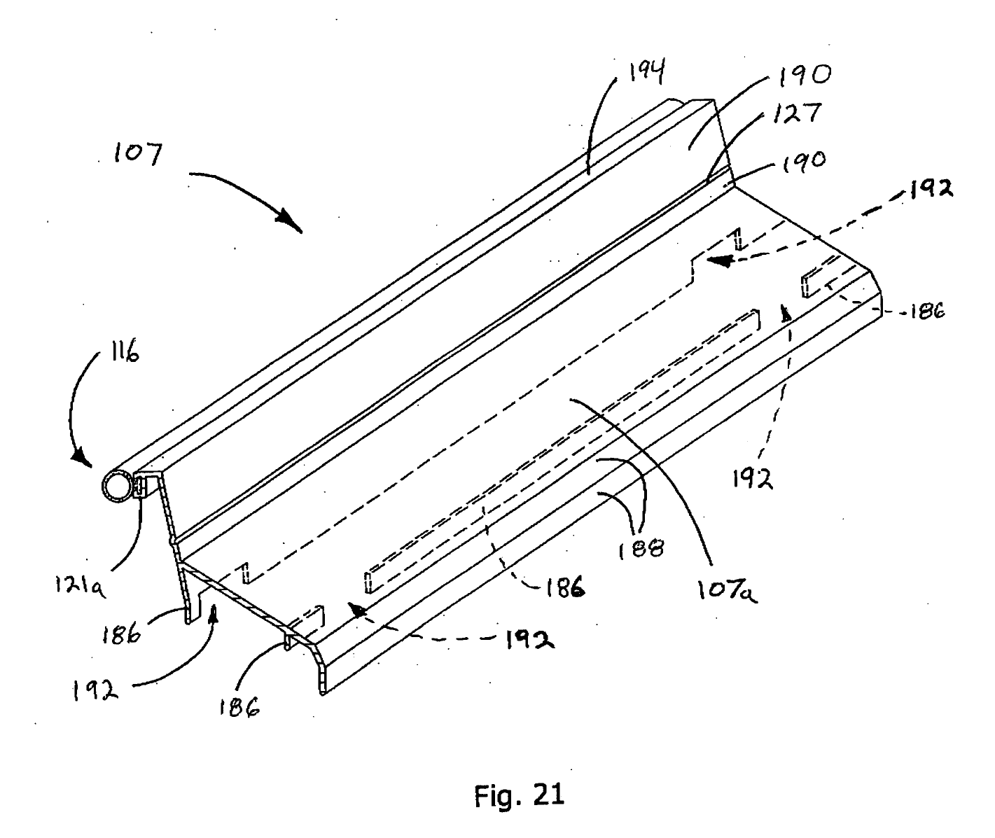

FIG. 21 is a perspective view of sill cladding 107 showing sill cladding support legs 186 comprising support leg drainage apertures 192. Sill cover riser 190 may also comprise one or more screw starting notches 127 for positioning cover mounting screws 134 (not shown) at an appropriate height to enter frame sill 154 (not shown). As indicated above, notches 127 may be used with self tapping screws which may be used to hold sill cladding 107 against a wood or metal frame sill 154 (not shown).

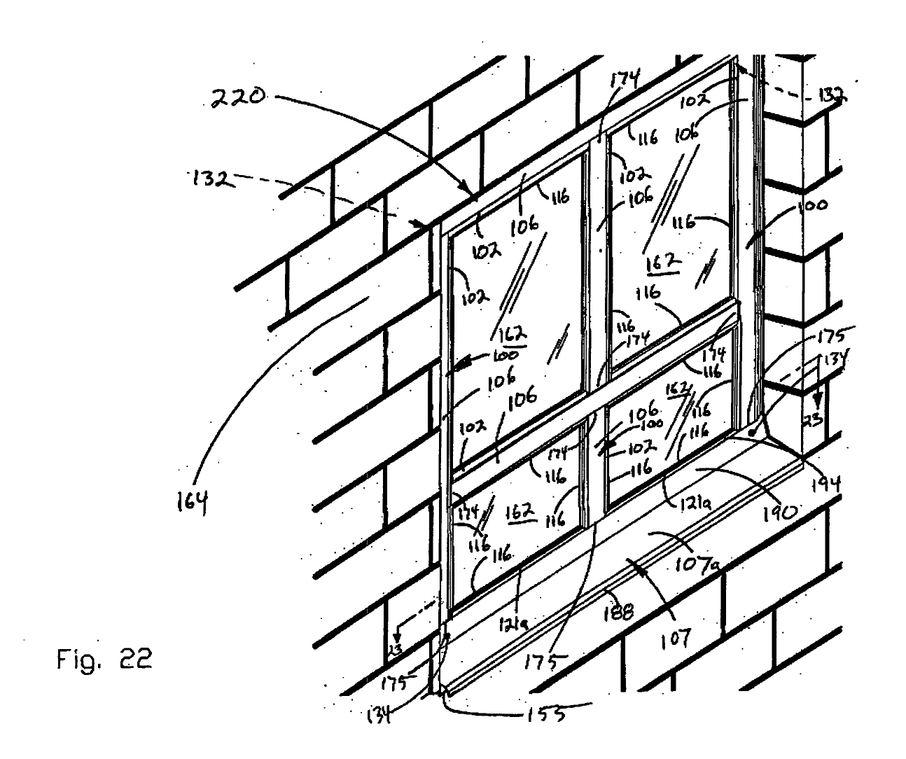

FIG. 22 is a perspective view of window 220 with frame and mullion cladding 100 and sill cladding 107 on the window of FIG. 19. Vertical frame cladding 100 and lower vertical mullion cladding 100 is shown terminating with horizontal ends 175 that mate with upper horizontal mating surface 194 of sill cladding 107. Sill cover riser 190 is shown without screw starting notch 127 but with cover mounting screws 134.

FIG. 22a is a fragmented perspective view showing vertical frame cover 173 terminating in horizontal end 175 mating with mating surface 194 and showing cap end 106a of cap 106 on vertical frame cover 173. Vertical cladding 173 and sill cladding 107 both have bulbs 118 resting against an outer surface of window pane 162 with bulbs 118 meeting at bulb junction 119.

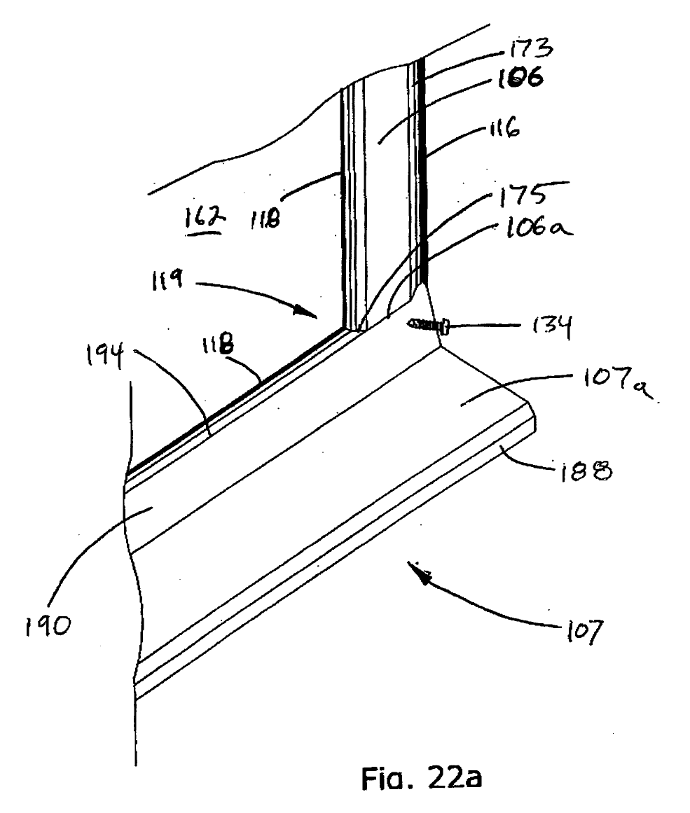

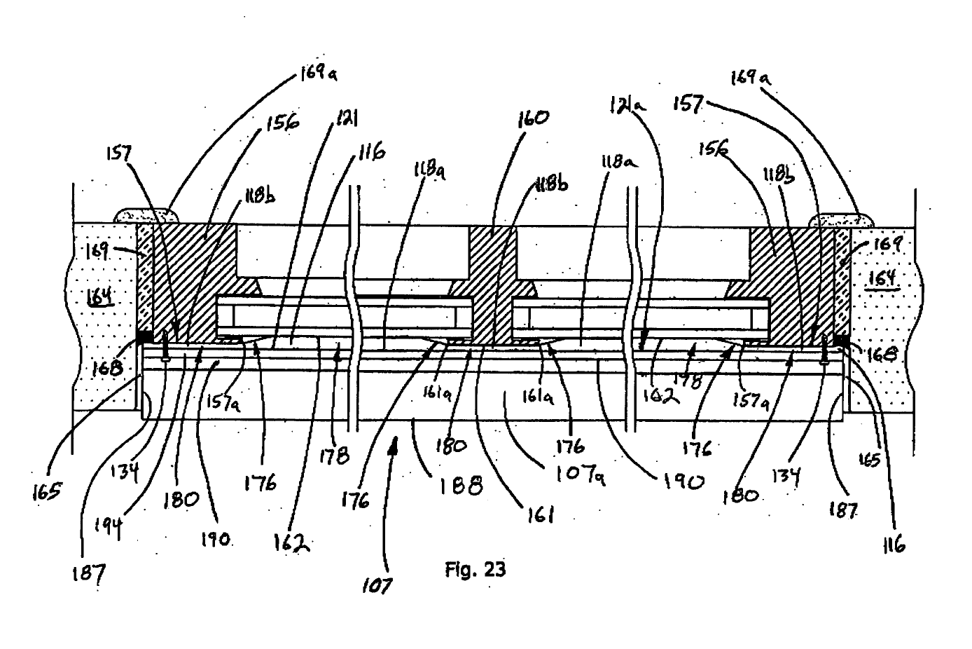

FIG. 23 is a horizontal sectional top view of the window of FIG. 22 taken along line 23-23 showing sill cladding 107 with sill gasket 116 applied against frame faces 157 of frame jambs 156, against the front face 161 of vertical mullion 160, and against outer window pane surfaces 162, with vertical frame and mullion cladding removed for clarity. Sill cladding 107 includes mating surface 194 at the upper end of sill cover riser 190, terminating at gasket compression surface 121. Gasket 116 is shown in differing degrees of compression with bulb 118a being in a lesser state of compression against outer surface of window pane 162 and bulb 118b being in a greater state of compression against frame jambs 156 and vertical mullion 160. Where bulb 118a, 118b transitions from bulb compressed at 118a to bulb compressed at 118b forms gasket compression gap 176 similar to that created in FIG. 11. Again, gasket compression gap 176 is typically filled with caulking or other sealant. Such sealing may be left off of the examples of FIG. 11 or 23 where vertical bulbs 118a of vertical frame covers 173 and vertical mullion cover 172 snugly mate with sill gasket bulb 118a at gasket compression gaps 176 between said vertical gaskets 118a and exterior frame sides 157a or exterior mullion sides 161a, as the case may be. To reduce the amount of coverage of window pane surface 162, gasket compression gaps 176 may be filled with caulking or other sealant as above-mentioned so that vertical gaskets may rest against, or be as close as possible, to exterior frame sides 156a and exterior mullion sides 161a.

Sill cladding 107 comprises sill ends 187, which define sill gaps 165. As the window openings in which a length of sill cladding 107 may be placed will vary slightly from window opening to window opening, the length of sill cladding 107 must be short enough to fit into the narrowest anticipated window opening to avoid having to cut sill cladding 107 to fit on site. Although sill gaps 165 are shown exaggerated for clarity, the sill gaps 165 should be as small as possible. Sill gaps 165 would typically be covered by sill caulking 167 (shown in FIGS. 29 and 30). Cover mounting screws 134 holding sill cladding 107 against frame jambs 156 or frame sill 154 are shown exposed to show typical mounting locations although only the heads of screws 134 are typically visible in this sectional view.

FIG. 24 is similar to FIG. 23 except that instead of one gasket 116 (not shown), two frame gaskets segments 185a, mullion gasket segment 185a and two window pane gasket segments 185 are inserted into gasket retaining track 120 (not shown) such that window pane gasket segments 185 may compress against the exterior of window pane surfaces 162 where frame sides 157a and mullion sides 161a meet the exterior surface of window panes 162. Gasket segments 185, 185a run for the length of sill cladding 107, and gasket segments 185, 185a abut end to end in the order in which they are placed into gasket retaining track 120. Another approach to providing separate gasket segments that are physically separated from one another includes cutting bulb 118 (not shown) or otherwise providing a gasket relief 182 so that bulb segments 183 (not shown) of bulb 118 (not shown) may compress at different depths creating substantially no gasket compression gap 176. Examples of such arrangements may be seen above in FIGS. 11a and 14 with respect to cladding 100.

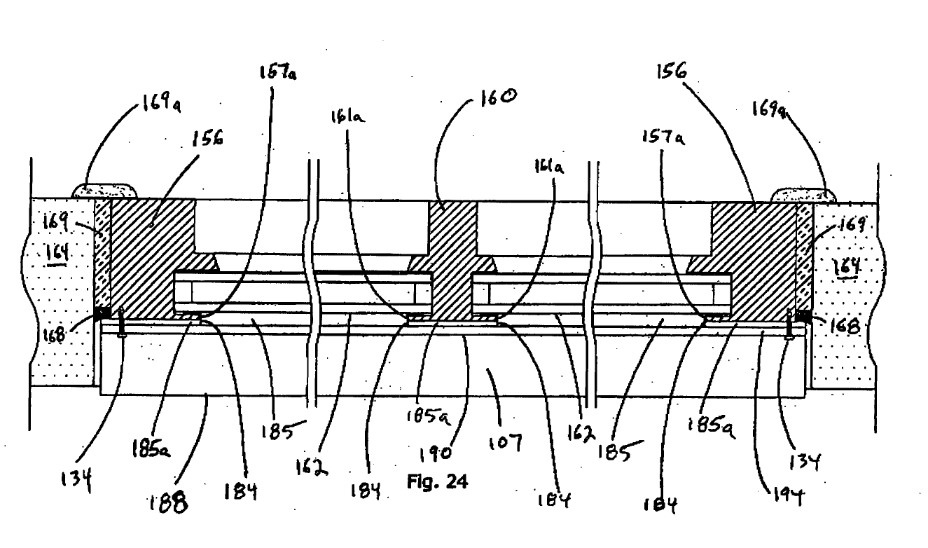

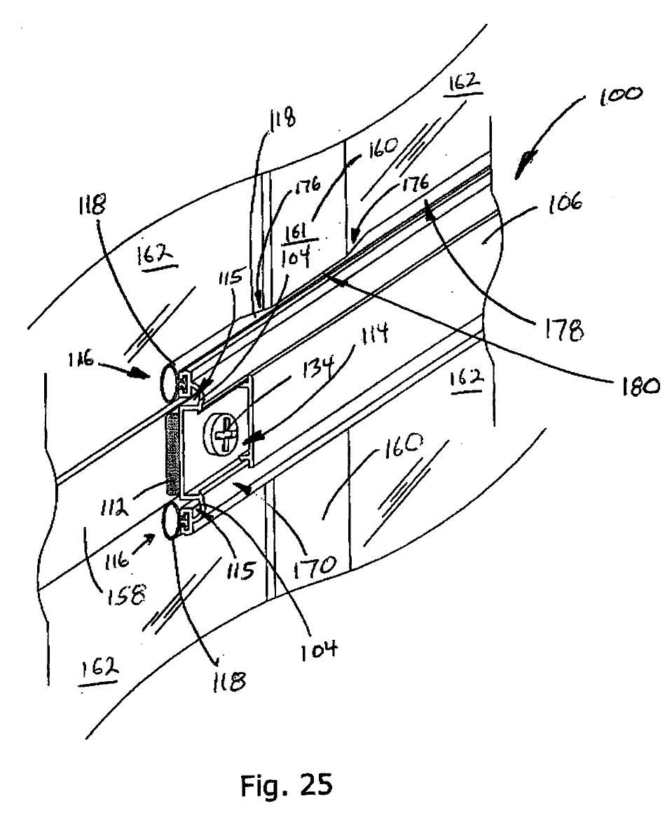

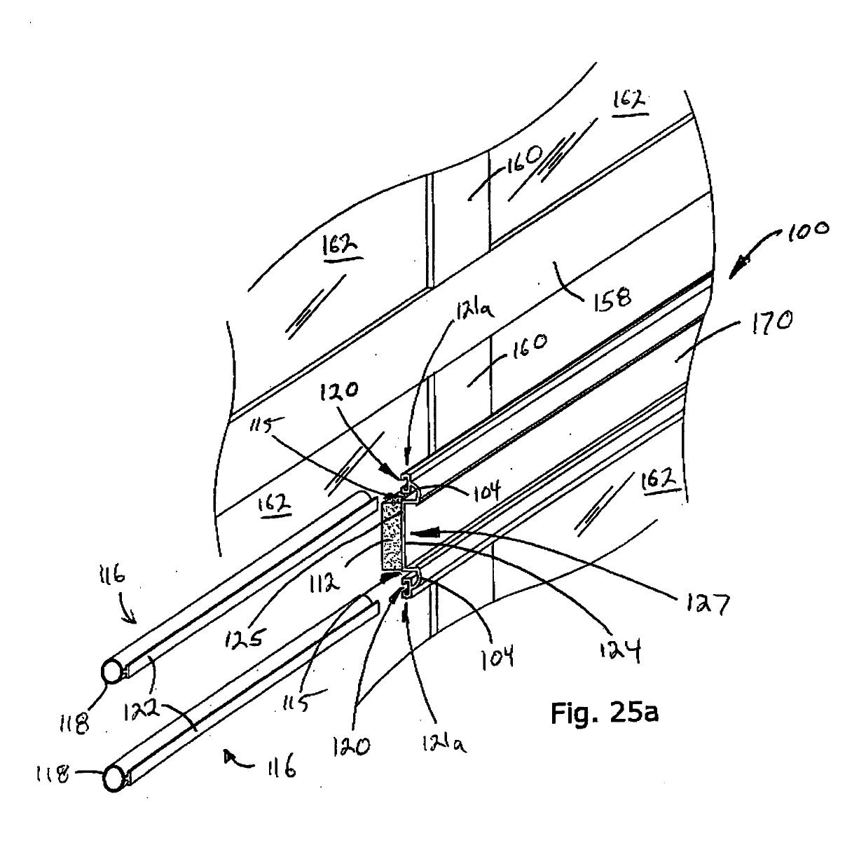

FIG. 25 is a fragmented perspective view of a horizontal mullion cladding 100 comprising horizontal mullion cover 170 showing upper bulb gasket 116 with bulb 118 shown at different states of compression against outer surfaces of window pane 162 and against vertical mullion face 161, causing gasket compression gaps 176.

FIG. 25a is an exploded perspective view of the horizontal window mullion cladding 100 of FIG. 25 showing separate upper and lower lengths of gasket 116, each having gasket retaining head element 122 for insertion into gasket retaining tracks 120.

FIG. 26 is a fragmented perspective view of horizontal mullion cover 170 and cap 106 wherein gasket 116 comprises window pane gasket segments 185 and mullion gasket segment 185a, wherein segments 185, 185a are of different diameters.

FIG. 26a is an exploded perspective view of the horizontal mullion cladding of FIG. 26, showing gasket segments 185, 185a to be separate pieces not connected to one another and wherein bulb 118 of mullion gasket segment 185a is of a different diameter than bulbs 118 of window pane gasket segments 185.

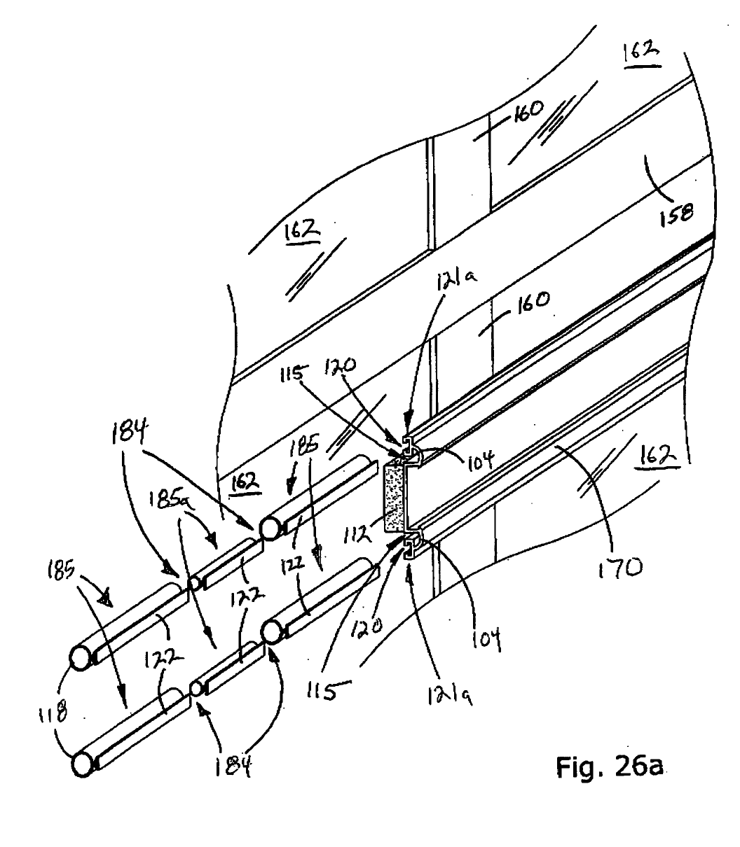

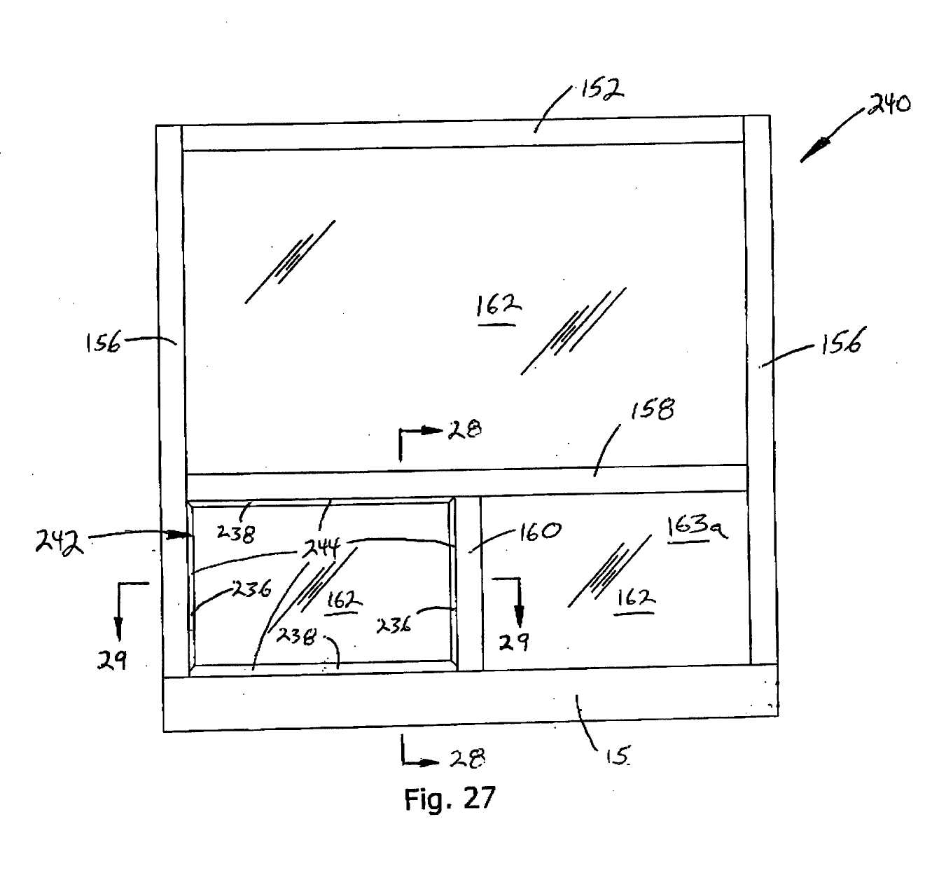

FIG. 27 is a front view of a prior art window 240 with slidable sash 242 having sash frame 244. Window 240 has upper horizontal frame head 152, frame sill 154 and frame jambs 156, horizontal mullion 158, lower vertical mullion 160, vertical sash stiles 236 and horizontal sash rails 238.

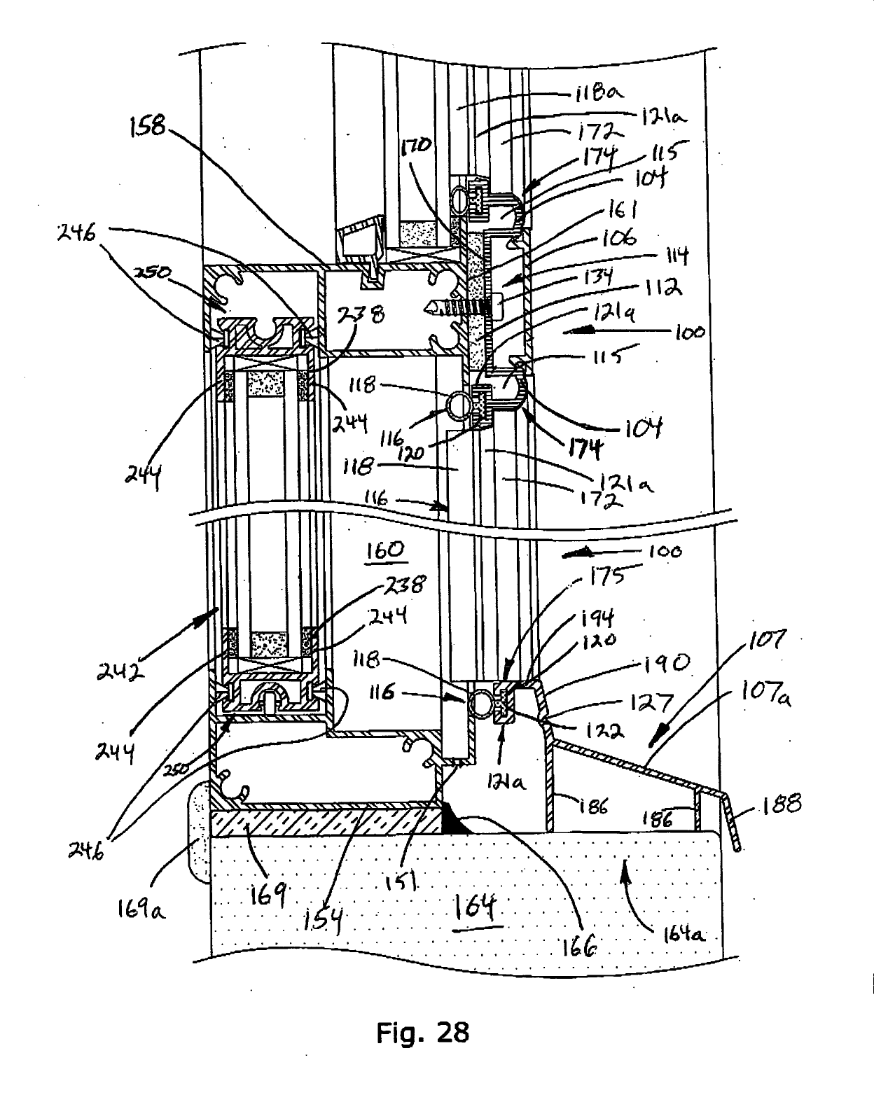

FIG. 28 is a vertical sectional side view of the sash assembly of FIG. 27 taken along line 28-28, with cladding 100 mounted horizontally on horizontal mullion 158 and with cladding 100 mounted vertically on lower vertical mullion 160 and sill cladding 107 mounted against sill 154. FIG. 28 shows horizontal mullion cover 170 with lower gasket compression head 121a retaining gasket 116 with uncompressed bulb 118. In this example, bulb 118 is not compressed against any surface, and gasket 116 is primarily inserted in gasket retaining track 120 for esthetics, that is to match other gasket usages about the sash. Accordingly, in this example, lower gasket 116 may be omitted to reduce the cost of cladding. By another approach, the side of bulb 118 may rest against a bottom horizontal surface of horizontal mullion 158 to create a sealed cavity for lower side thermal break 115. In this approach, the location of lower arm 104 of horizontal mullion cover 170 over sash access 301 is dictated by where said arm 104 lies over the top of the window pane surface 162 of horizontally adjacent stationary window pane 163 a because the same profile of cladding 100 is used across the whole of horizontal mullion 158. A different size, profile or type of gasket with gasket retaining head element 122 could be inserted in track 120, as shown in FIG. 26a, at the top of sash access 301, to seal lower arm 104 of cover 102 to horizontal mullion 158. FIG. 28 also shows vertical mullion cover 172 with upper contoured cover end 174 meeting with the contour of lower arm 104 of horizontal mullion cover 170. Sash side gasket compression head 121a of vertical mullion cover 172 is cut to fit between the horizontal bottom of sash side gasket compression head 121a of horizontal mullion cover 170 and the top of mating surface 194 of sill cover 107a. Gasket retaining head element 122 (not shown) of gasket 116 may be inserted into gasket retaining track 120 (not shown) of vertical mullion cover 172 on the sash side of vertical mullion 160 for aesthetic reasons. As before, vertical gasket 116 on the sash side of vertical mullion 160 may be omitted to potentially reduce production costs or provide an alternate look.

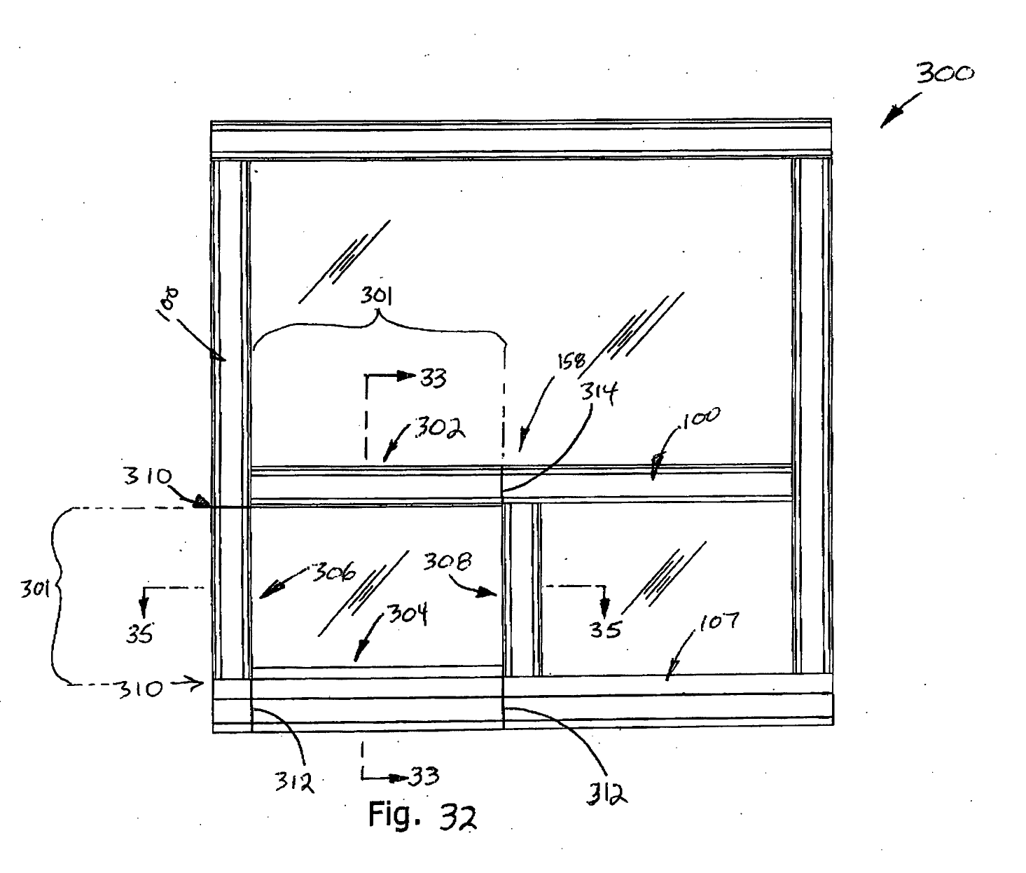

Sill cladding 107 is shown in FIG. 28 resting on the bottom of window opening 164a of building wall 164 upon sill cladding support legs 186. Sill cladding support legs 186 can be shortened to accommodate a sill projection 155 (not shown) or an angled sill forming part of the bottom of opening in building wall 164a. Gasket compression head 121a of sill cladding 107 again retains gasket retaining head element of 122 of gasket 116 in gasket retaining track 120. Again, the use of gaskets 116 in this example at sash access 301 (as shown in FIG. 32) may be purely ornamental. In another example, bulb 118 may rest against a surface of frame sill 154; however, the exact juxtaposition of sill gasket 116 adjacent sash access 301 will be determined by the height and depth at which sill gasket 116 engages the exterior window pane surface 162 of the stationary pane 163 horizontally adjacent sash opening 301. Because the locations of the gaskets 116 bounding sash access 301 in this example are primarily aesthetic, the precise locations of the gaskets bounding sash access 301 are not critical. A different frame gasket segment 185a, however, may be inserted into track 120 of sill 107 adjacent sash access 301 so that a seal may be made with sill 154. In yet another approach, a different profile of sill cladding 107 may be used where it bounds sash access 301 as in FIGS. 32, 33, 34, and 35.

Although sill cladding support legs 186 have support leg drainage apertures 192 (not shown), new caulking 166 may be applied over insulation 169 to seal frame sill 154 to building wall 164 as a prophylactic measure before sill cladding 107 is installed. Caulking 166 is applied as discussed above because the covered area would no longer be accessible once sill cladding 107 has been installed and because any water accumulating in or about the sash may tend to accumulate at the bottom of the window opening 164a in building wall, for example where cladding 100, 107 does not seal against slidable sash 242 and water may be directed to the bottom of the opening 164a in building wall 164 by original drainage holes 151 in or about frame sill 154.

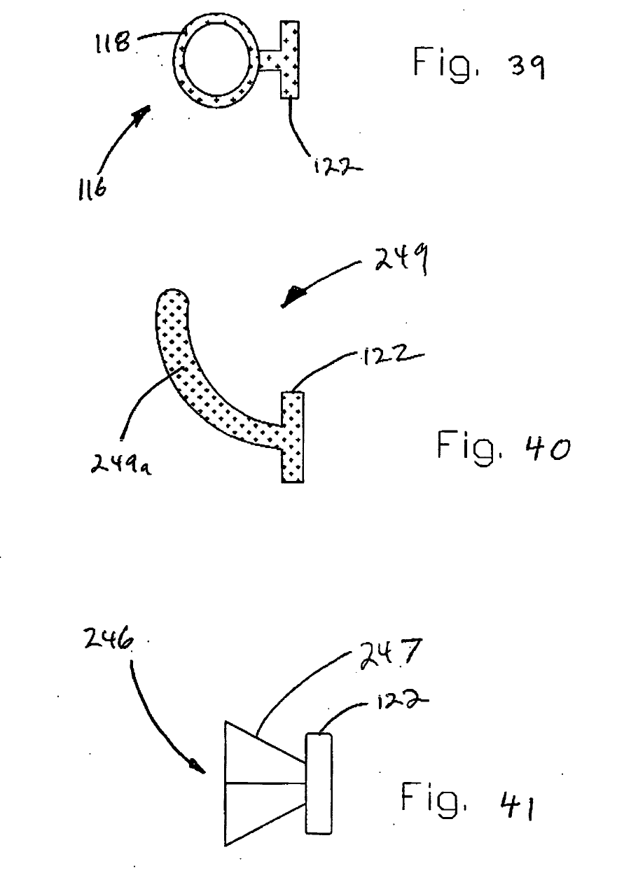

FIG. 28 generally shows slidable sash 242 with sash frame 244 sliding within upper and lower sash tracks 250 in horizontal mullion 158 and frame sill 154, respectively. Sash rails 238 are sealed on opposing vertical sides against the inside vertical surfaces of sash tracks 250 by pile gaskets 246 shown in graphic representation (as shown in FIG. 41).

FIG. 29 is a horizontal sectional top view of the sash assembly of FIGS. 27 and 28 taken along line 29-29 of FIG. 27 showing the location of vertical frame cover 173 and vertical mullion cover 172. FIG. 29 shows inner gasket 116 of frame cover 173 in uncompressed state, such portion of vertical gasket 116 bounding sash access 301 being substantially ornamental in nature. Uncompressed portions of gasket 116 could be removed for a different look. FIG. 29 also shows vertical bulb gasket 116 of vertical mullion cover 172 bounding sash access 301 in uncompressed state. As shown in FIG. 29, again, that portion of gasket 116 of vertical mullion cover 172 bounding sash access 301 may be removed for a different appearance. By another approach, said vertical gasket 116 bounding sash 301 may abut the sash side of vertical mullion 160 to create a sealed cavity thereby creating side thermal break 115.

In the background, sill cladding 107 is attached to frame sill 154 (not shown) by means of cover mounting screw 134 (head only showing). Continuous gasket 116 is shown as attached to sill cover 107 by means of gasket retaining head element 122 (not shown) and gasket retaining track (not shown). Bulb 118 of horizontal gasket 116 is shown compressed under vertical thermal break 112 of frame jamb 156 and transitioning to an uncompressed state adjacent to sash access 301 and then transitioning to a compressed state where bulb 118 is compressed between cover back 125 and vertical mullion face 161. Angled sill cover 107a transitions downwardly into sill cover overhang 188 to lead water away from building wall 164 and frame sill 154.

FIG. 29 shows slidable sash 242 in closed position with the window jamb end of sash 242 sealed in sash bay 251 by pile gaskets 246 shown abutting sash bay 251. Sash 242 is slidable away from sash bay 251 along lower sash track 250 and upper sash track 250 (not shown).

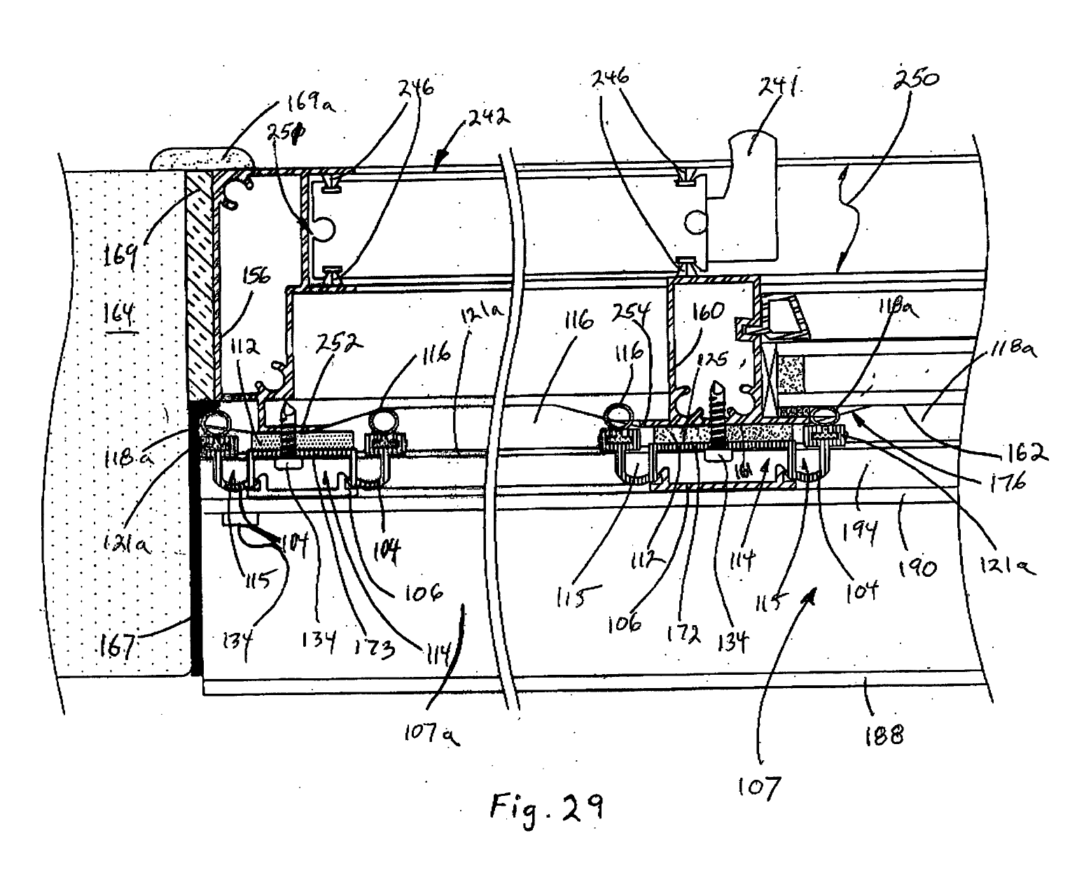

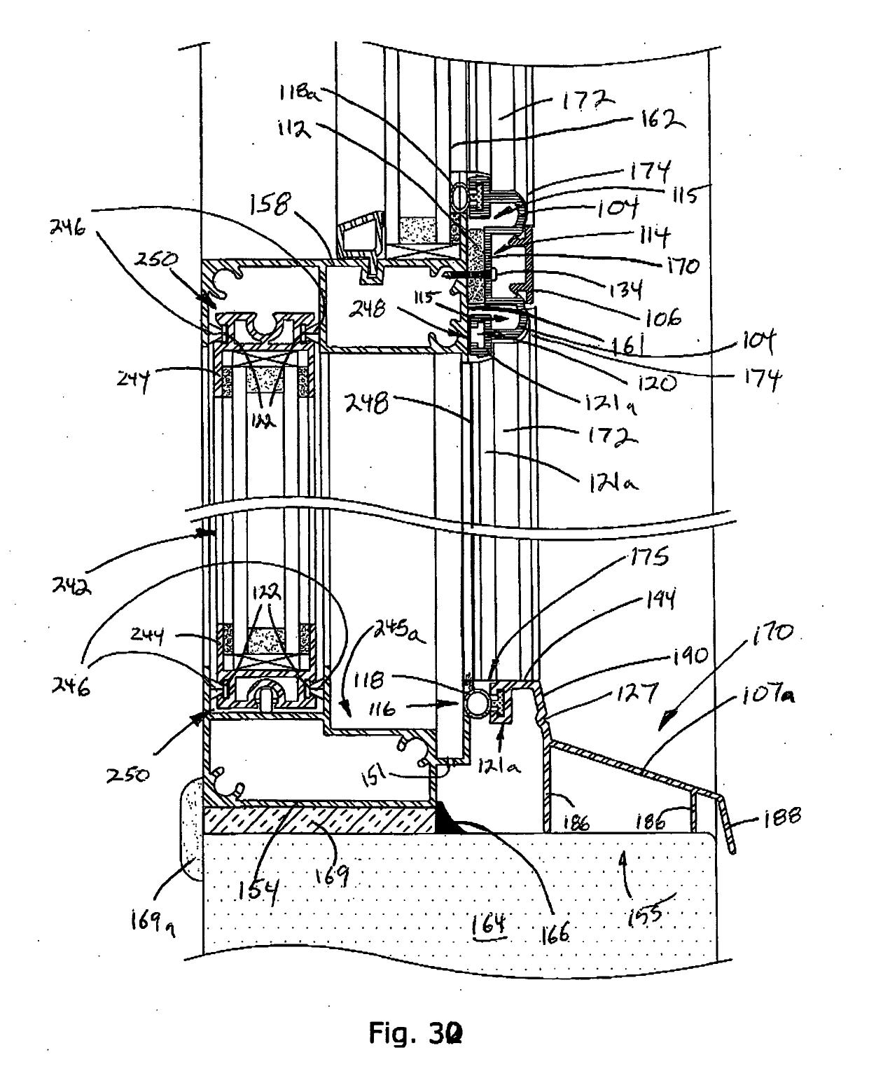

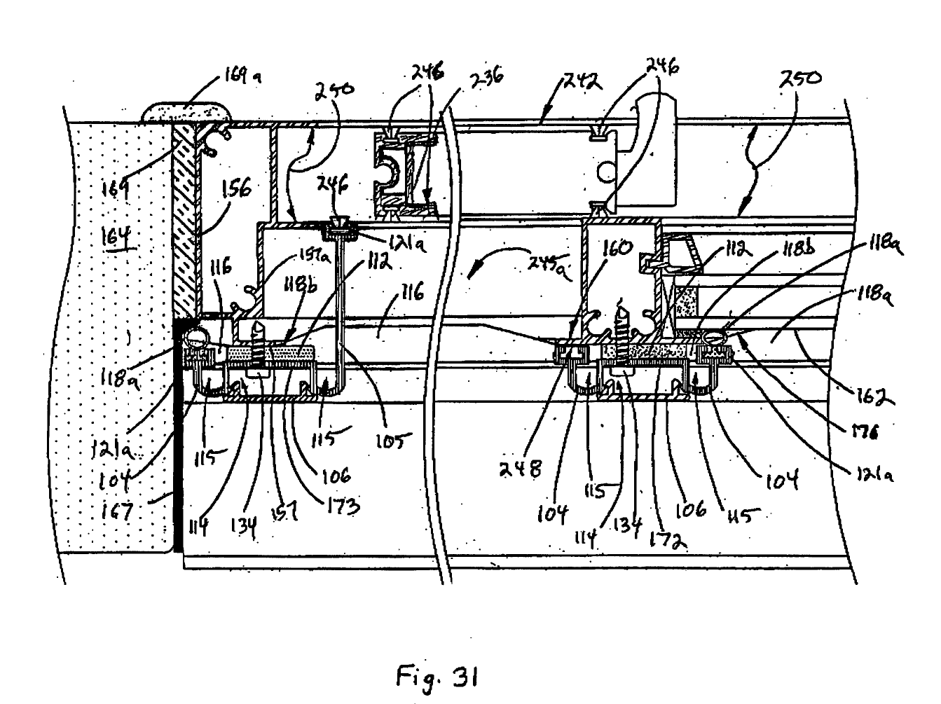

FIG. 30 is similar to FIG. 28 except that lower gasket compression head 121a of horizontal mullion cover 170, in particular gasket compression surfaces 121, are sealed against horizontal mullion face 161 by flat gasket 248. In the background, gasket compression head 121a of vertical mullion cover 172 is shown sealed against vertical mullion face 161 by flat gasket 248, also shown in FIG. 31. Lower arm 104 of horizontal mullion cover 170, however, will typically not line up against the face 157 of the horizontal mullion 158 unless a separate horizontal mullion sash cladding segment 302, as shown in FIG. 32, is used as shown in FIG. 30. By another approach, a specially sized gasket may be installed in track 120 of lower arm 104 of horizontal mullion cover 170, as shown in FIG. 26a, where the track 120 bounds sash access 301.

In still another approach, sill cladding 107 may be such that bulb 118 is compressed along a horizontal flat surface of frame sill 154 bounding sash access 301. Sill gasket 116 may also be arranged to abut a front or other surface of sill 154 across the entire width of sill 154 where, for instance, a double sliding sash runs the entire width of a window from jamb to jamb.

FIG. 31 shows vertical frame cover 173 with elongate arm 105 terminating in gasket compression head 121a with gasket retaining track 120 for holding gasket retaining head element 122 of pile gasket 246 for abutting sash stile 236. The area under elongate arm 105 comprises a larger side thermal break 115. Although cladding 100, 107 is attached by means of a gasket or otherwise against the members defining sash access 301, namely vertical frame jamb 156, vertical mullion 160, horizontal mullion 158 and frame sill 154, water that would otherwise tend to pool in sash access floor 245a may still rely upon original drainage holes 151 in frame sill 154. Accordingly, a means for water to escape from the bottom of the opening in building wall 164 through support leg drainage apertures 192 in support legs 186 may be used. Other ways of draining water pooling in sill well 245 may be applied.

Vertical frame cover 173 with elongate arm 105 and alternative pile gasket 246 with gasket retaining head element 122 held in gasket compression head 121a of elongate arm 105 may be arranged to abut outer frame face 157. Gaskets 116, 246, 249 attached to gasket compression head 121a of frame covers 173 abutting sash access 301 may compress against frame side 157a.

FIG. 32 is a front view of cladded window 300 with movable sash showing horizontal mullion sash cladding segment 302 over sash access 301 with cladding 100 over the balance of horizontal mullion 158. The profile of cladding 100 changes to the profile of cladding 302 at horizontal mullion profile division 314. Vertical mullion sash cladding segment 308 runs from the lower side of horizontal mullion cladding 100 to mating surface 194 of sill cladding 107 but does not change profile as the entirety of the vertical mullion cover abuts sash access 301. Vertical frame sash cladding segment 306 abutting sash access 301 is different from cladding 100 used for the balance of frame jamb 156 with the profile of cladding 306 and 100 changing at frame cover profile division 310. Horizontal sill sash cover segment 304 under sash access 301 has a different profile than sill cladding 107 used to cover the remainder of sill 154 (not shown), with the sill profiles changing at sill cover profile divisions 312.

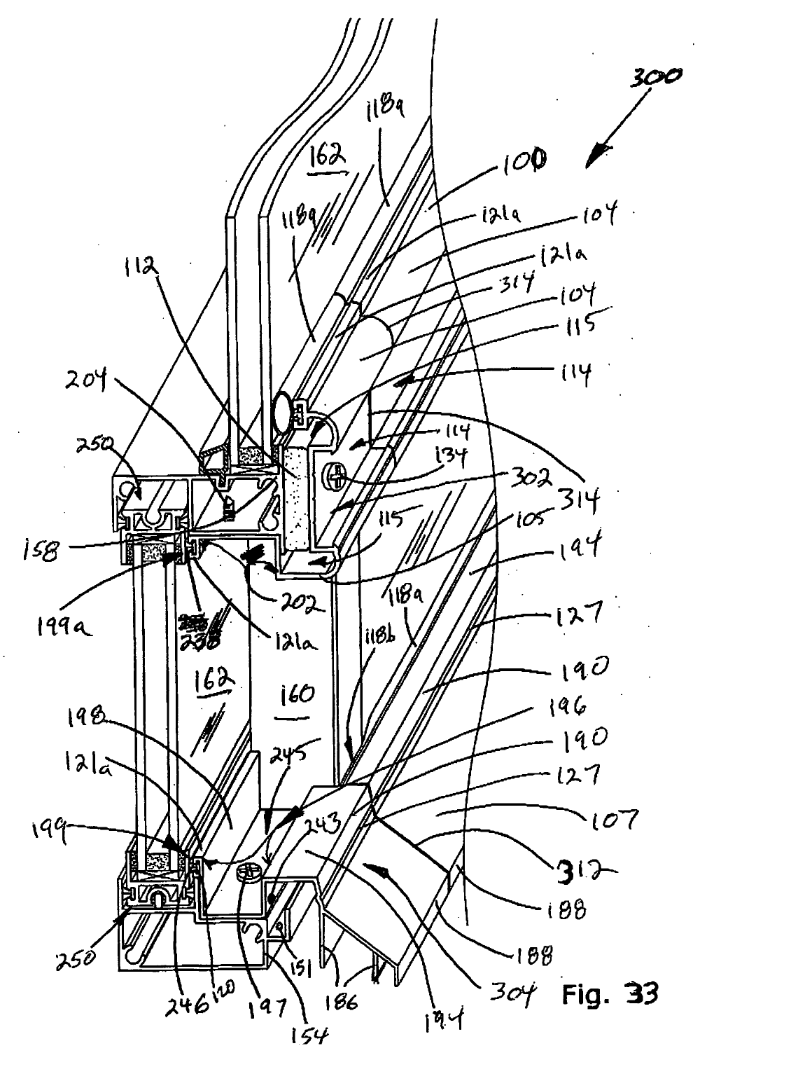

FIG. 33 is a fragmented perspective view showing two different profiles of horizontal mullion cladding 101, 302 and two different profiles of sill cladding 304, 107. The profile of cladding 101 changes to profile of cladding 302, or other desired profile for overlying sash access 301 at horizontal mullion cladding division 314. The front views of cladding 100, 302 are substantially identical, including upper arms 104, front curvature of lower arms 104, upper gasket compression head 121a and upper gasket 116 with upper gasket 118a of both cladding 100 and 302 of substantially equal compression, and usually with approximately equal sized outer thermal breaks and cover teeth 108 to allow a single cap 106 to overlie the covers of both cladding 100 and 302. Gasket compression head 121a and gasket 116 of lower arm 104 of cladding 101 compresses against outer surface of stationary window pane 162. Cladding 302 differs from cladding 101 in that lower arm 105 is elongated and transitions into horizontal mullion sash cladding extension 202, which may terminate with gasket compression head 121a having gasket retaining track 120 for receiving gasket retaining head element 122 of pile gasket 246, which bears upon upper sash rail 238. Horizontal mullion sash cladding extension 202 is further secured by horizontal mullion cladding extension screws 204. To ensure that aluminum or other metal, and other materials if desired, of cladding 302 does not transfer substantial amounts of heat or cold to horizontal mullion 158, a thermal break (not shown), which may be an extension of side thermal break 115, may be placed between the upper surface of horizontal mullion sash cladding extension 202 and the lower side of horizontal mullion 158. The thermal break may comprise a closed cell foam or other barrier similar to inner thermal break 112, an air gap as in outer thermal break 114, a gasket such as a flat gasket made of EPDM, or other suitable materials. Extension 202, terminating with gasket 246, is a further barrier against water leakage at the sash 242, especially during hard wind driven rain storms.

Similarly, horizontal sill sash cover segment 304 would typically have a front profile identical to sill cladding 107, which may abut end to end at sill cover profile divisions 312 to provide consistent run-off surfaces. Sill covers 107a, sill cover overhangs 188, sill cover risers 190, screw starting notches 127 (if used) and a portion of mating surfaces 194 (for abutting vertical cladding) would usually be substantially identical. Horizontal sill sash cover segment 304 and sill cladding 107 may also be joined together by welding or other means along sill cover profile divisions 312, as sill cladding support legs 186 may comprise support leg drainage apertures 192 in the event any water leaks through divisions 312. The water leaks would then typically run off the bottom of the opening 164a of building wall 164 along with any water draining through drain holes 151, 243. Similarly, frame cover profile divisions 310 and mullion cover profile divisions 314, 316 may also be joined together.

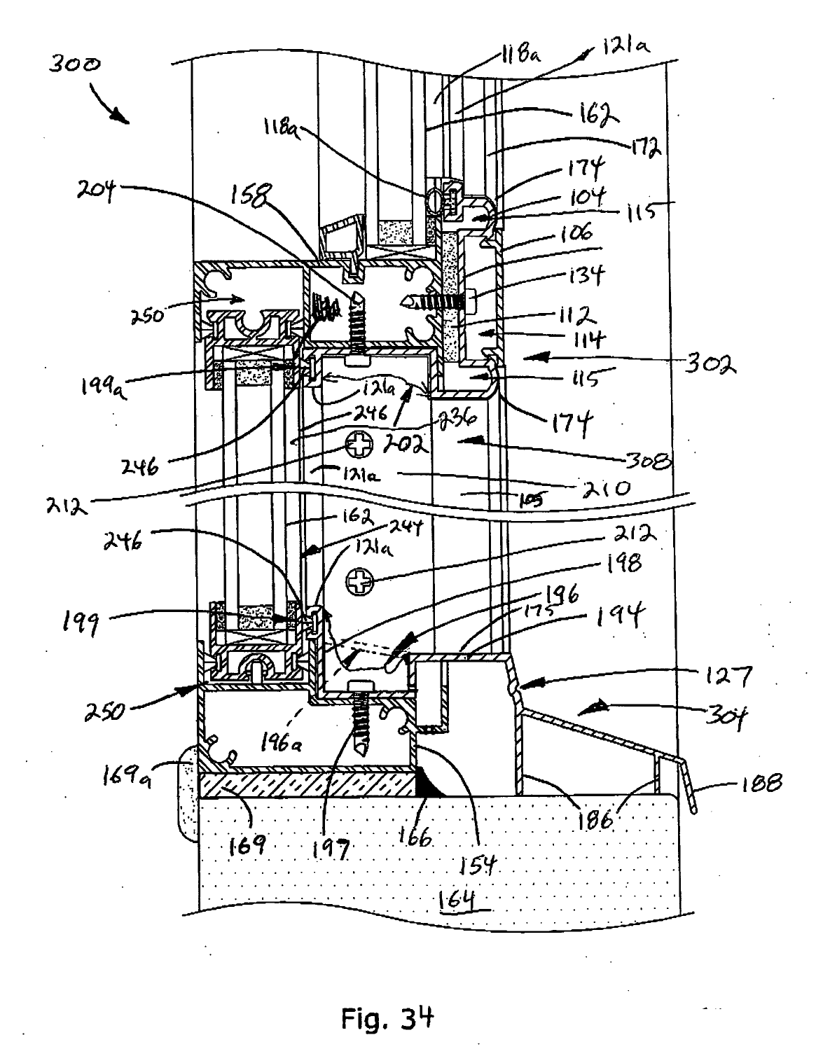

Horizontal sill sash cover segment 304 comprises a deeper mating surface 194 and sill sash extension 196, which terminates with gasket compression head 121a having gasket retaining track 120 with pile gasket 246, which in turn rests against lower sash rail 199. Sill sash extension 196 may include sash well 245, which may require drainage means, typically apertures such as sash well drain holes 243, allowing pooling of water in sash well 245 to escape under horizontal sill sash cover segment 304 and to run off sill 154 and the bottom of opening 164a of building wall 164. Depending on the precise construction of the existing sash, alternate extension 196a may also be constructed in order for rain water to run off of extension 196a (not shown) over mating surface 194, along angled sill cover 107a and off sill cover overhang 188. The profile of alternate extension 196a is shown in dashed lines in FIG. 34. Extension 196a may be sealed at its longitudinal ends (not shown) that abut vertical mullion 160 and vertical frame jamb 156 (not shown) by caulking or other means. Sill extension screws 197 may also further secure sash sill extension 196 in addition to cover mounting screws 134 for holding sill cover riser 190 against frame sill 154. Vertical mullion cladding has been shown removed in FIG. 33 for clarity.

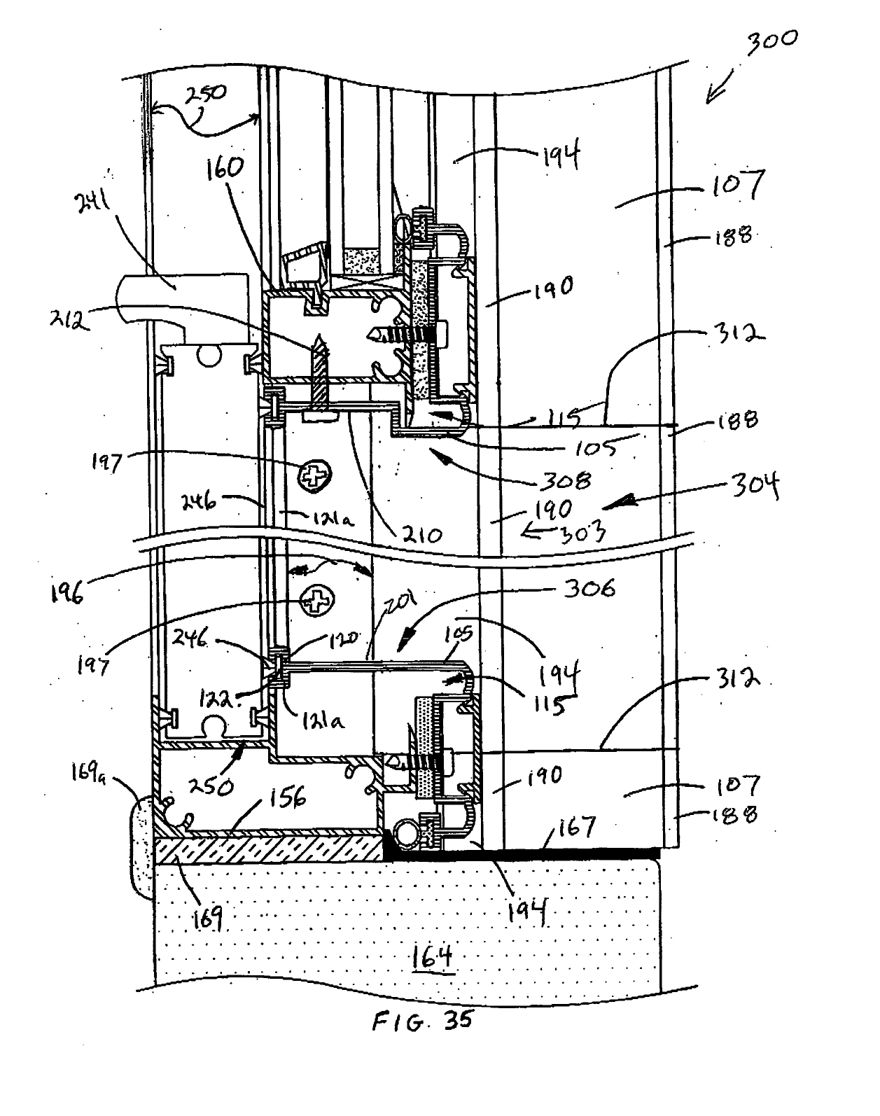

As is the case with mullion sash cladding extension 202 above, there would usually be provided a thermal break such as one of the kinds mentioned herein between sash sill extension 196 and a top surface of sill 154. The same applies to vertical mullion sash cladding segment 308, wherein a thermal break would usually be provided between vertical mullion sash cladding extension 210 and vertical mullion 160, as shown in FIG. 35. The same applies to vertical frame sash cladding segment 306, wherein a thermal break would usually be provided between vertical frame sash cladding extension 201 (which may be different from elongated arm 105) and vertical frame jamb 156, as shown in FIG. 35.

FIG. 34 is a vertical sectional side view of cladded window 300 showing horizontal mullion sash cladding segment 302 having horizontal mullion sash cladding extension 202 and horizontal sill sash cover segment 304 having sash sill extension 196. FIG. 34 shows vertical mullion sash cladding segment 308 having horizontal end 175 resting on mating surface 194 of horizontal sill sash cover segment 304, said vertical mullion sash cladding segment 308 having upper contoured cover end 174, which mates with a side of lower arm 104 of cladding 100 of horizontal mullion cover 170 (not shown). Vertical mullion sash cladding segment 308 also comprises vertical mullion sash cladding extension 210 shown attached to vertical mullion 160 (not shown) by vertical mullion cladding extension screws 212, extension 210 terminating with gasket compression head 121a shown in background with gasket 246 therein resting on sash stile 236.

FIG. 35 is a horizontal sectional top view of window 300 of FIGS. 33 and 34. FIG. 35 shows horizontal sill sash cover segment 304 in the background, including sash sill extension 196 shown attached to frame sill 154 (not shown) by sill extension screws 197. Horizontal sill sash cover segment 304 is shown between two sections of sill cladding 107, horizontal sill sash cover segment 304, substantially covering the horizontal width of sash access 301. FIG. 35 also shows vertical mullion sash cladding segment 308 as shown in FIG. 34 with lower horizontal end 175 (not shown) resting on the top of mating surface 194 of horizontal sill sash cover segment 304. Cladded sash access 303 is bounded by elongate arm 105 of vertical frame sash cladding segment 306, said arm 105 terminating in gasket compression head 121a in turn comprising gasket retaining track 120 for receiving gasket retaining head element 122 of pile gasket 246, which rests against sash stile 236 when sash 242 is in a closed position.

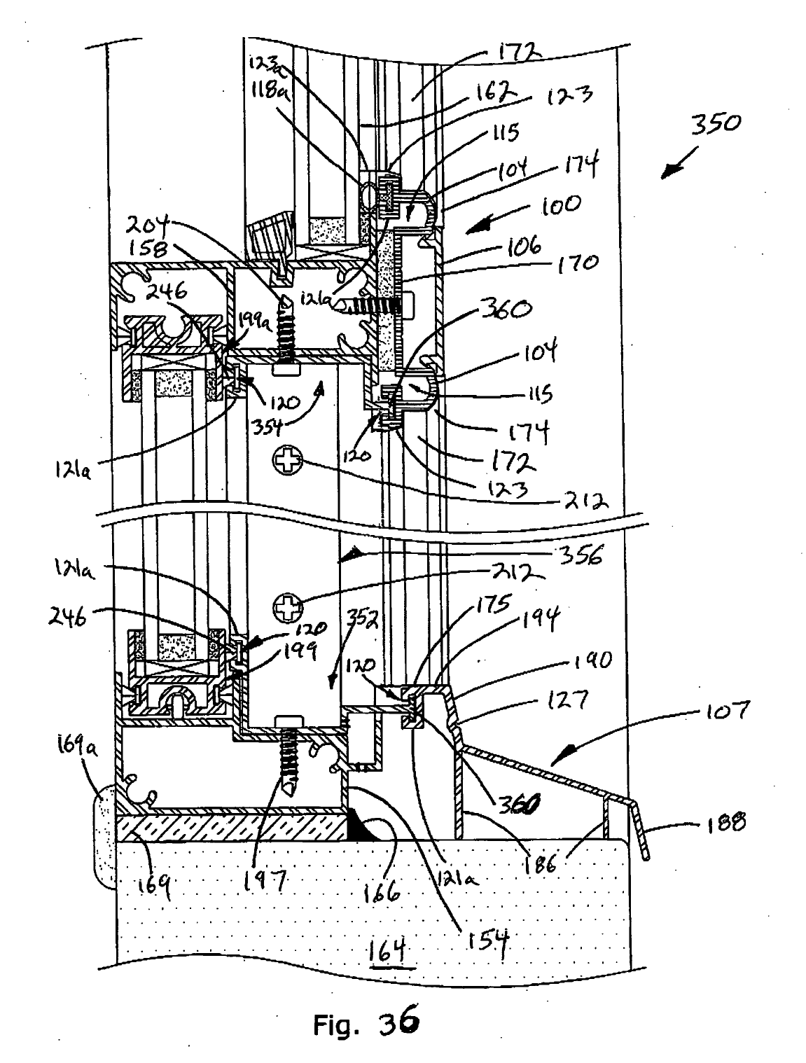

FIG. 36 shows window cladding 350 with sash cladding inserts 352, 354, 356 instead of using horizontal mullion sash cladding segment 302. Basic cladding 100 may be used to clad horizontal mullion 158, and upper horizontal sash cladding insert 354 having track engaging element 360 is inserted into gasket retaining track 120 of cover 170. This allows the sash access 301 to be cladded with insert 354 while one profile of cladding 170 may be used across both sash access 301 and over horizontally adjacent outer stationary window pane surface 162 (not shown). Similarly, one profile of sill cladding 107 may be used across the entirety of the bottom of horizontal opening 164a in building wall 164. Track engaging element 360 of lower horizontal sash cladding insert 352 fills track 120 of sill cladding 107 where lower horizontal sash cladding insert 352 enters horizontal sash access 301. The remainder of track 120 typically contains gasket retaining element 122 of gaskets 116, having bulbs 118 that compress against vertical frame jamb 156 and vertical mullion 160 vertically bounding sash access 301.

Mullion side vertical sash cladding insert 356 shown in the background in FIG. 36 also comprises track engaging element 360 (not shown), which is inserted in gasket retaining track 120 of vertical mullion cover 172. Mullion side vertical sash cladding insert 356 is also held in place by vertical mullion cladding extension screws 212. Lower horizontal sash cladding insert 352 may similarly be held in place by sill extension screws 197.

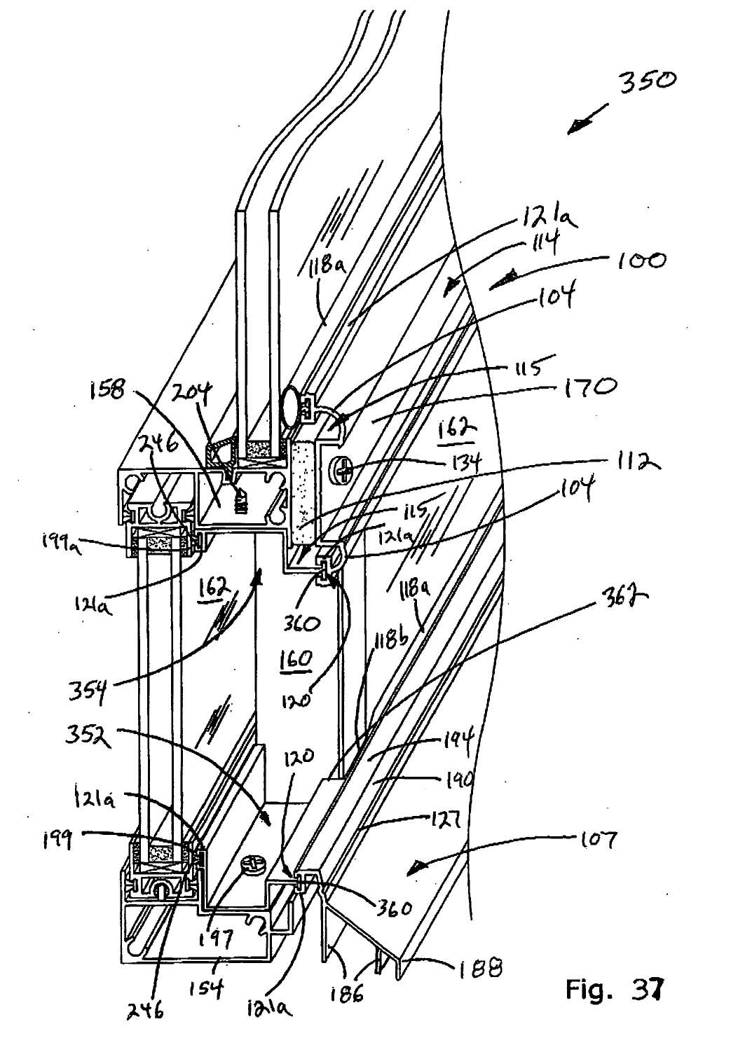

FIG. 37 is a perspective view of the cladding inserts of FIG. 36 with vertical mullion cladding removed for clarity. FIG. 37 shows insert end 362 of lower horizontal sash cladding insert 352 abutting the sash side of vertical mullion 160. Bulb gasket 116 is installed in remainder of track 120 of sill cladding 107 and substantially abuts insert end 362 with bulb 118b pressed against mullion face 161. Bulb 118a continues along horizontally adjacent outer window pane surface 162.

Similarly, the embodiment described in FIGS. 36 and 37 also includes frame side vertical sash cladding insert 358 (not shown) also having track engaging element 360 for insertion into gasket retaining track 120 of vertical frame cover 173 (not shown). Frame side vertical sash cladding insert 358 at the opposite end from track engaging element 360 terminates in gasket compression head 121a comprising gasket retaining track 120, which in turn comprises gasket retaining head element 122 of pile gasket 246. Pile gasket 246 rests against frame side sash stile 236 when the sash 242 is in the closed position.

As is the case with extensions 196, 201, 202, and 210, a thermal break as described herein will often be provided between inserts 352, 354, 356, and 358 and the frame or mullion to which each is attached.

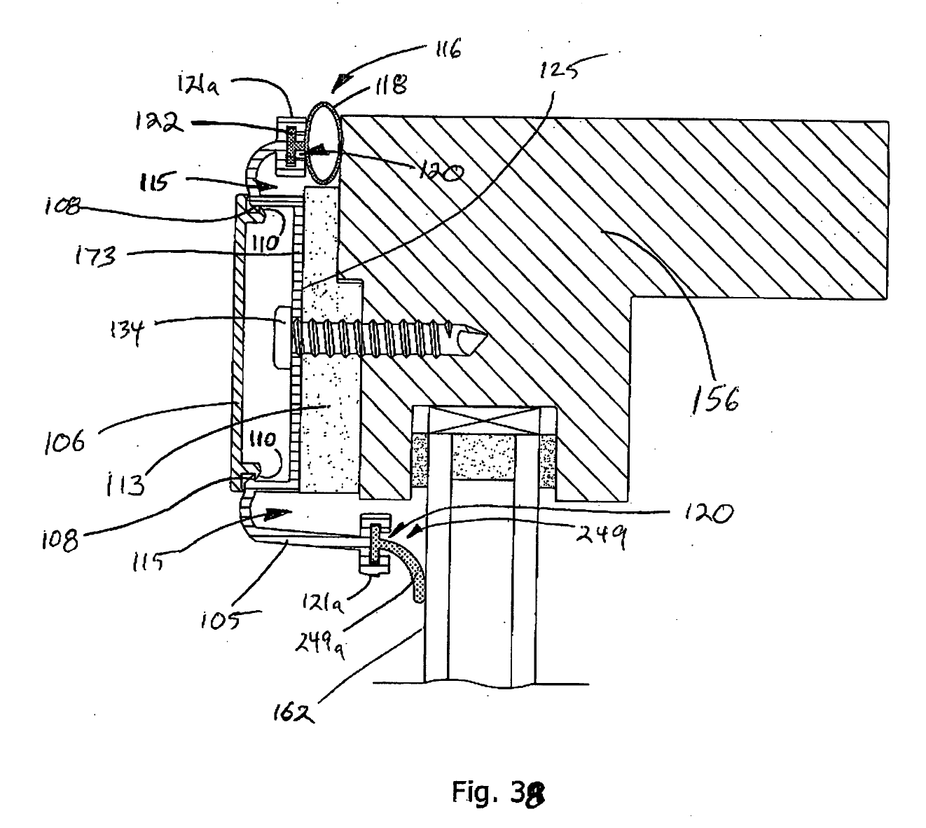

FIG. 38 is a sectional top view of an another approach for an inner thermal break adapted to conform to the shape of a frame jamb 156 showing the use of a leaf gasket 249 of FIG. 40 against outer windowpane surface 162. As depicted in FIG. 38, frame jamb 156 has frame faces 157 of different depths on the same jamb. Multi-depth inner thermal break 113 is shown with profile adapted to conform to the differences in depths in frame faces 157. Inner thermal break 113 is typically cut or formed to fit the multiple depths or profiles of the front of frame jamb 156. Cover 173 is shown with elongate arm 105 defining side thermal break 115, elongate arm 105 terminating in gasket compression head 121a comprising gasket retaining track 120 for receiving gasket retaining head element 122 of leaf gasket 249 showing leaf head 249a against window pane surface 162. Different shapes and profiles of gasket will perform substantially the same function in substantially the same way to produce substantially the same result.

FIG. 39 is a blow up of gasket 116 with bulb 118 and gasket head retaining element 122.

FIG. 40 shows leaf gasket 249 with leaf head 249a and gasket retaining head element 122 as described above.

FIG. 41 is a graphic representation of pile gasket 246 having pile 247 and gasket retaining head element 122.

The above embodiments should only be viewed as examples of various ways in which the invention may be practiced and should not be construed as limiting the scope of the invention in any way.

We claim:

1. An apparatus for covering at least a portion of a window pane support member and at least one joint for the window pane support member comprising:
a cover having first and second longitudinal opposing sides, the cover configured to be attachable to the window pane support member to cover at least a portion of the window pane support member and the at least one joint;
a first seal operatively attached to the first longitudinal opposing side, the first seal running substantially parallel to the longitudinal axis of the cover and configured to provide a substantially water resistant seal against at least one of a window pane, a window pane support member, and a window sealing material;
a second seal operatively attached to the second longitudinal opposing side, the second seal running substantially parallel to the longitudinal axis of the cover and configured to provide a substantially water resistant seal against at least one of a window pane, a window pane support member, and a window sealing material.

2. The apparatus of claim 1 wherein the first seal is configured to seal the cover to a first window pane and the second seal is configured to seal the cover to a second window pane when the cover is attached to the window pane support member.

3. The apparatus of claim 1 wherein the first seal and the second seal comprise gaskets.

4. The apparatus of claim 3 wherein the gaskets comprise at least one of a group comprising a bulb gasket, a pile gasket, and a leaf gasket.

5. The apparatus of claim 3 wherein at least one of the gaskets comprises at least one of EPDM or PVC.

6. The apparatus of claim 1 further comprising at least one thermal break disposed at least in part along at least one of the cover, the first seal, and the second seal.

7. The apparatus of claim 6 wherein the at least one thermal break comprises an inner thermal break disposed between the cover and the window pane support member.

8. The apparatus of claim 7 wherein the inner thermal break comprises a closed cell foam attached to the cover.

9. The apparatus of claim 8 wherein the closed cell foam comprises EPDM.

10. The apparatus of claim 7 wherein the inner thermal break comprises an air gap when the strip is installed over the window pane support member.

11. The apparatus of claim 6 wherein the at least one thermal break further comprises an outer thermal break comprising a cavity along the cover.

12. The apparatus of claim 11 wherein the cavity is defined at least in part by a removable cap engaging the cover.

13. The apparatus of claim 12 wherein the outer thermal break contains at least one of air and closed cell foam.

14. The apparatus of claim 13 wherein the closed cell foam comprises EPDM.

15. The apparatus of claim 6 wherein the at least one thermal break further comprises at least one side thermal break comprising a cavity bounded by at least one of the first seal and the second seal.

16. The apparatus of claim 15 wherein the side thermal break contains at least one of air and closed cell foam.

17. The apparatus of claim 16 wherein the closed cell foam comprises EPDM.

18. The apparatus of claim 1 further comprising a first arm connected along at least a portion of the first longitudinal opposing side and a second arm connected along at least a portion of the second longitudinal opposing side, the first arm and the second arm supporting seal retaining tracks.

19. The apparatus of claim 1 further comprising a sill cladding comprising a seal retaining track supporting a sill cladding seal, a sill cover riser extending from the seal retaining track to a sill cover, the sill cover riser configured to be attachable to at least one window pane support member such that the sill cladding seal provides a substantially water resistant seal against at least one of a window pane, a vertical window pane support member, and a window sealing material and the sill cover extends over at least a part of a window sill.

20. The apparatus of claim 19 wherein the sill cladding further comprises sill cladding support legs extending from the sill cover and configured to contact the window sill.

21. The apparatus of claim 19 wherein the sill cladding further comprises a sill cover overhang configured to extend past an edge of the window sill.

22. The apparatus of claim 1 wherein at least one of the first seal and the second seal further comprise caulk applied along the at least one of the first seal and the second seal.
